(19) United States
(12) Patent Application Publication
(10) Pub. No.: US 2025/0176062 A1
(43) Pub. Date: May 29, 2025

(54) TECHNIQUES FOR CONFIRMATION OF CELL DISCONTINUOUS TRANSMISSION AND RECEPTION ACTIVATION

(71) Applicant: QUALCOMM Incorporated, San Diego, CA (US)

(72) Inventors: Ahmed Attia ABOTABL, San Diego, CA (US); Diana MAAMARI, San Diego, CA (US); Hung Dinh LY, San Diego, CA (US)

(21) Appl. No.: 18/521,494

(22) Filed: Nov. 28, 2023

(51) Int. Cl. H04W 76/28; H04W 72/1268; H04W 72/21

(52) U.S. Cl. CPC H04W 76/28; H04W 72/1268; H04W 72/21

(57) ABSTRACT

Methods, systems, and devices for wireless communications are described that provide for implicit or explicit indication of receipt of a cell discontinuous reception (DRX) activation. The indication may be provided in a configured grant transmission from a user equipment (UE) prior to a non-active period of a cell DRX configuration that includes a skipping indication the UE will skip one or more configured grant uplink transmissions during the cell non-active period. The indication of receipt of the cell DRX activation also may be provided in an uplink reference signal, in which a first reference signal sequence may indicate that the cell DRX configuration is active at the UE, and a second reference signal sequence may indicate the cell DRX configuration is not active at the UE.

### FIELD OF TECHNOLOGY

The following relates to wireless communications, including techniques for confirmation of cell discontinuous transmission and reception activation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for confirmation of cell discontinuous transmission and reception (DRX) activation. For example, the described techniques provide for implicit or explicit indication of receipt of a cell DRX activation. In some aspects, a configured grant transmission prior to a non-active period of a cell DRX configuration may include a skipping indication that indicates the UE will skip one or more configured grant uplink transmissions during the cell non-active period. In some aspects, the skipping indication may be provided in uplink control information (UCI) transmitted from a user equipment (UE). Additionally, or alternatively, the indication of receipt of the cell DRX activation may be provided in a reference signal (e.g., a sounding reference signal), in which a first reference signal sequence may indicate that the cell DRX configuration is active at the UE, and a second sequence may indicate the cell DRX configuration is not active at the UE.

A method for wireless communications by a user equipment (UE) is described. The method may include receiving configuration information for a cell discontinuous reception configuration that indicates one or more cell non-active periods during which a serving cell does not monitor for communications from the UE, receiving an activation message that activates the cell discontinuous reception configuration, and transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

A UE for wireless communications is described. The UE may include one or more memories storing processor executable code, and one or more processors coupled with the one or more memories. The one or more processors may individually or collectively operable to execute the code to cause the UE to receive configuration information for a cell discontinuous reception configuration that indicates one or more cell non-active periods during which a serving cell does not monitor for communications from the UE, receive an activation message that activates the cell discontinuous reception configuration, and transmit a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

Another UE for wireless communications is described. The UE may include means for receiving configuration information for a cell discontinuous reception configuration that indicates one or more cell non-active periods during which a serving cell does not monitor for communications from the UE, means for receiving an activation message that activates the cell discontinuous reception configuration, and means for transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

A non-transitory computer-readable medium storing code for wireless communications is described. The code may include instructions executable by one or more processors to receive configuration information for a cell discontinuous reception configuration that indicates one or more cell non-active periods during which a serving cell does not monitor for communications from the UE, receive an activation message that activates the cell discontinuous reception configuration, and transmit a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

In some examples of the method, UEs, and non-transitory computer-readable medium described herein, the first uplink transmission may be transmitted in a last configured grant resource allocation within a cell active period prior to the first cell non-active period. Some examples of the method, UEs, and non-transitory computer-readable medium described herein may further include operations, features, means, or instructions for determining the one or more configured grant occasions that overlap with the first cell non-active period, and where the skipping indication identifies each of the one or more configured grant occasions that overlap with the first cell non-active period.

Some examples of the method, UEs, and non-transitory computer-readable medium described herein may further include operations, features, means, or instructions for transmitting, subsequent to a deactivation of the cell discontinuous reception configuration, a second uplink transmission in accordance with the configured grant resource allocation, where the second uplink transmission does not include the skipping indication and signals that a subsequent activation message that activates the cell discontinuous reception configuration has not been received at the UE. In some examples of the method, UEs, and non-transitory computer-readable medium described herein, the skipping indication may be provided in uplink control information (UCI) included with the first uplink transmission. In some examples of the method, UEs, and non-transitory computer-readable medium described herein, the skipping indication includes a bitmap of the one or more configured grant occasions that overlap with the first cell non-active period. In some examples of the method, UEs, and non-transitory computer-readable medium described herein, the UCI may have a same UCI format as a first UCI format that indicates skipping at the UE due to a lack of data to transmit, or may have a different UCI format than the first UCI format.

In some examples of the method, UEs, and non-transitory computer-readable medium described herein, the skipping indication provides both the confirmation that the activation message was successfully received at the UE and an indication that one or more configured grant occasions that overlap with a cell active period are to be skipped. In some examples of the method, UEs, and non-transitory computer-readable medium described herein, the skipping indication includes a bitmap of the one or more configured grant occasions that overlap with the first cell non-active period and the cell active period.

In some examples of the method, UEs, and non-transitory computer-readable medium described herein, the transmitting the first uplink transmission may include operations, features, means, or instructions for multiplexing UCI that includes the skipping indication with a physical uplink shared channel transmission that is included in the first uplink transmission, and where the UCI has a higher priority than other UCI that indicates only that one or more configured grant occasions that overlap with a cell active period are to be skipped.

A method for wireless communications by a UE is described. The method may include receiving configuration information for a cell discontinuous reception configuration that indicates one or more cell non-active periods during which a serving cell does not monitor for communications from the UE, receiving an activation message that activates the cell discontinuous reception configuration, and transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

A UE for wireless communications is described. The UE may include one or more memories storing processor executable code, and one or more processors coupled with the one or more memories. The one or more processors may individually or collectively operable to execute the code to cause the UE to receive configuration information for a cell discontinuous reception configuration that indicates one or more cell non-active periods during which a serving cell does not monitor for communications from the UE, receive an activation message that activates the cell discontinuous reception configuration, and transmit a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

Another UE for wireless communications is described. The UE may include means for receiving configuration information for a cell discontinuous reception configuration that indicates one or more cell non-active periods during which a serving cell does not monitor for communications from the UE, means for receiving an activation message that activates the cell discontinuous reception configuration, and means for transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

A non-transitory computer-readable medium storing code for wireless communications is described. The code may include instructions executable by one or more processors to receive configuration information for a cell discontinuous reception configuration that indicates one or more cell non-active periods during which a serving cell does not monitor for communications from the UE, receive an activation message that activates the cell discontinuous reception configuration, and transmit a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

Some examples of the method, UEs, and non-transitory computer-readable medium described herein may further include operations, features, means, or instructions for selecting the first reference signal sequence for an uplink sounding reference signal based on successful receipt of the activation message, and where the second reference signal sequence is selected for the uplink sounding reference signal when the activation message that activates the cell discontinuous reception configuration is not received at the UE. In some examples of the method, UEs, and non-transitory computer-readable medium described herein, the first reference signal sequence may be determined based on a first seed value for reference signal generation, and the second reference signal sequence may be determined based on a second seed value for reference signal generation.

Some examples of the method, UEs, and non-transitory computer-readable medium described herein may further include operations, features, means, or instructions for transmitting, subsequent to a deactivation of the cell discontinuous reception configuration, a second uplink reference signal including the second reference signal sequence, where the second reference signal sequence indicates that a subsequent activation message that activates the cell discontinuous reception configuration has not been received at the UE. In some examples of the method, UEs, and non-transitory computer-readable medium described herein, the first uplink reference signal and the second uplink reference signal may be sounding reference signals.

A method for wireless communications by a network entity is described. The method may include transmitting, to a UE, configuration information for a cell discontinuous reception configuration that indicates one or more cell non-active periods during which a serving cell associated with the network entity does not monitor for communications from the UE, transmitting, to the UE, an activation message that activates the cell discontinuous reception configuration, and receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

A network entity for wireless communications is described. The network entity may include one or more memories storing processor executable code, and one or more processors coupled with the one or more memories. The one or more processors may individually or collectively operable to execute the code to cause the network entity to transmit, to a UE, configuration information for a cell discontinuous reception configuration that indicates one or more cell non-active periods during which a serving cell associated with the network entity does not monitor for communications from the UE, transmit, to the UE, an activation message that activates the cell discontinuous reception configuration, and receive, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

Another network entity for wireless communications is described. The network entity may include means for transmitting, to a UE, configuration information for a cell discontinuous reception configuration that indicates one or more cell non-active periods during which a serving cell associated with the network entity does not monitor for communications from the UE, means for transmitting, to the UE, an activation message that activates the cell discontinuous reception configuration, and means for receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

A non-transitory computer-readable medium storing code for wireless communications is described. The code may include instructions executable by one or more processors to transmit, to a UE, configuration information for a cell discontinuous reception configuration that indicates one or more cell non-active periods during which a serving cell associated with the network entity does not monitor for communications from the UE, transmit, to the UE, an activation message that activates the cell discontinuous reception configuration, and receive, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

In some examples of the method, network entities, and non-transitory computer-readable medium described herein, the first uplink transmission may be transmitted in a last configured grant resource allocation within a cell active period prior to the first cell non-active period. In some examples of the method, network entities, and non-transitory computer-readable medium described herein, the skipping indication identifies each of the one or more configured grant occasions that overlap with the first cell non-active period.

Some examples of the method, network entities, and non-transitory computer-readable medium described herein may further include operations, features, means, or instructions for transmitting, subsequent to a deactivation of the cell discontinuous reception configuration, a second activation message that re-activates the cell discontinuous reception configuration, receiving, from the UE, a second uplink transmission in accordance with the configured grant resource allocation, where the second uplink transmission does not include the skipping indication, and determining that the UE did not receive the second activation message. In some examples of the method, network entities, and non-transitory computer-readable medium described herein, the skipping indication may be provided in UCI included with the first uplink transmission. In some examples of the method, network entities, and non-transitory computer-readable medium described herein, the skipping indication includes a bitmap of the one or more configured grant occasions that overlap with the first cell non-active period. In some examples of the method, network entities, and non-transitory computer-readable medium described herein, the UCI may have a same UCI format as a first UCI format that indicates skipping at the UE due to a lack of data to transmit, or may have a different UCI format than the first UCI format.

In some examples of the method, network entities, and non-transitory computer-readable medium described herein, the skipping indication provides both the confirmation that the activation message was successfully received at the UE and an indication that one or more configured grant occasions that overlap with a cell active period are to be skipped. In some examples of the method, network entities, and non-transitory computer-readable medium described herein, the skipping indication includes a bitmap of the one or more configured grant occasions that overlap with the first cell non-active period and the cell active period.

In some examples of the method, network entities, and non-transitory computer-readable medium described herein, the receiving the first uplink transmission may include operations, features, means, or instructions for demultiplexing UCI that includes the skipping indication and a physical uplink shared channel transmission that is included in the first uplink transmission, and where the UCI has a higher priority than other UCI that indicates only that one or more configured grant occasions that overlap with a cell active period may be to be skipped.

A method for wireless communications by a network entity is described. The method may include transmitting, to a UE, configuration information for a cell discontinuous reception configuration that indicates one or more cell non-active periods during which a serving cell associated with the network entity does not monitor for communications from the UE, transmitting, to the UE, an activation message that activates the cell discontinuous reception configuration, and receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active.

A network entity for wireless communications is described. The network entity may include one or more memories storing processor executable code, and one or more processors coupled with the one or more memories. The one or more processors may individually or collectively operable to execute the code to cause the network entity to transmit, to a UE, configuration information for a cell discontinuous reception configuration that indicates one or more cell non-active periods during which a serving cell associated with the network entity does not monitor for communications from the UE, transmit, to the UE, an activation message that activates the cell discontinuous reception configuration, and receive, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active.

Another network entity for wireless communications is described. The network entity may include means for transmitting, to a UE, configuration information for a cell discontinuous reception configuration that indicates one or more cell non-active periods during which a serving cell associated with the network entity does not monitor for communications from the UE, means for transmitting, to the UE, an activation message that activates the cell discontinuous reception configuration, and means for receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active.

A non-transitory computer-readable medium storing code for wireless communications is described. The code may include instructions executable by one or more processors to transmit, to a UE, configuration information for a cell discontinuous reception configuration that indicates one or more cell non-active periods during which a serving cell associated with the network entity does not monitor for communications from the UE, transmit, to the UE, an activation message that activates the cell discontinuous reception configuration, and receive, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active.

In some examples of the method, network entities, and non-transitory computer-readable medium described herein, the first reference signal sequence may be provided in an uplink sounding reference signal and indicates successful receipt of the activation message, and the second reference signal sequence may be provided in the uplink sounding reference signal when the activation message is not successfully decoded at the UE. In some examples of the method, network entities, and non-transitory computer-readable medium described herein, the first reference signal sequence may be determined based on a first seed value for reference signal generation, and the second reference signal sequence may be determined based on a second seed value for reference signal generation.

Some examples of the method, network entities, and non-transitory computer-readable medium described herein may further include operations, features, means, or instructions for transmitting, subsequent to a deactivation of the cell discontinuous reception configuration, a second activation message that re-activates the cell discontinuous reception configuration, receiving, from the UE, a second uplink reference signal including the second reference signal sequence, and determining that the UE did not receive the second activation message. In some examples of the method, network entities, and non-transitory computer-readable medium described herein, the first uplink reference signal and the second uplink reference signal may be sounding reference signals.

### BRIEF DESCRIPTION OF THE DRAWINGS

FIGS. 1 and 2 show examples of wireless communications systems that supports techniques for confirmation of cell discontinuous transmission and reception activation in accordance with one or more aspects of the present disclosure.

FIG. 3 shows an example of configured grant transmissions that support techniques for confirmation of cell discontinuous transmission and reception activation in accordance with one or more aspects of the present disclosure.

FIG. 4 shows an example of reference signal transmissions that support techniques for confirmation of cell discontinuous transmission and reception activation in accordance with one or more aspects of the present disclosure.

FIGS. 5 and 6 show examples of process flows that support techniques for confirmation of cell discontinuous transmission and reception activation in accordance with one or more aspects of the present disclosure.

FIGS. 7 and 8 show block diagrams of devices that support techniques for confirmation of cell discontinuous transmission and reception activation in accordance with one or more aspects of the present disclosure.

FIG. 9 shows a block diagram of a communications manager that supports techniques for confirmation of cell discontinuous transmission and reception activation in accordance with one or more aspects of the present disclosure.

FIG. 10 shows a diagram of a system including a device that supports techniques for confirmation of cell discontinuous transmission and reception activation in accordance with one or more aspects of the present disclosure.

FIGS. 11 and 12 show block diagrams of devices that support techniques for confirmation of cell discontinuous transmission and reception activation in accordance with one or more aspects of the present disclosure.

FIG. 13 shows a block diagram of a communications manager that supports techniques for confirmation of cell discontinuous transmission and reception activation in accordance with one or more aspects of the present disclosure.

FIG. 14 shows a diagram of a system including a device that supports techniques for confirmation of cell discontinuous transmission and reception activation in accordance with one or more aspects of the present disclosure.

FIGS. 15 through 25 show flowcharts illustrating methods that support techniques for confirmation of cell discontinuous transmission and reception activation in accordance with one or more aspects of the present disclosure.

### DETAILED DESCRIPTION

A wireless communications system may include a device, such as a user equipment (UE) or a network entity (e.g., an eNodeB (eNB), a next-generation NodeB or a giga-NodeB, either of which may be referred to as a gNB, or some other base station or network entity), that supports wireless communications using one or multiple radio access technologies. Examples of radio access technologies include 4G systems, such as LTE systems, 5G systems, which may be referred to as new radio (NR) systems, or other systems and radio technologies, including future systems and radio technologies not explicitly mentioned herein (e.g., sixth generation (6G) systems and beyond).

In some wireless communications systems, such as fifth generation (5G) or NR systems, a relatively large amount of power may be consumed by network components in some situations. For example, a network entity in a system that uses beamformed communications, such as a radio unit (RU) or a radio head, may transmit multiple directional beams in multiple directions. Such systems may provide information for use by a UE to access the wireless communications system (e.g., system information that provides parameters for system access) using beam sweeping techniques in which information is provided in multiple different transmissions in multiple different directions. For example, multiple instances of synchronization signal blocks (SSBs) and system information (SI) transmissions (e.g., remaining minimum system information (RMSI) transmissions) may be transmitted across multiple beams in multiple different directions according to a beam sweeping procedure. Such beam sweeping techniques may consume additional power relative to techniques that do not use beam sweeping (e.g., information provided in a single omni-directional transmission may consume less power than transmission of multiple instances of the information in multiple different directions). Further, such beam sweeping transmissions may be transmitted on multiple different cells, such as a primary cell (PCell) and one or more secondary cells (SCells).

In some cases, in order to reduce network power consumption, a network entity may transition to a sleep mode or non-active mode in which some or all transmit and receive circuitry is powered down. For example, during off-peak times, there may be no traffic or a light traffic load in a cell, and the network entity may stop or reduce periodic transmissions (e.g., SSB and SI transmissions) and periodic monitoring (e.g., monitoring for configured grant uplink (CG) transmissions, random access requests or small data transmission (SDT) communications), and transition to the non-active mode (e.g., in which periodic active periods may be used to monitor for a wake-up signal (WUS) from a served device such as a user equipment (UE)). A network entity that transitions between the active mode and non-active mode may be referred to as operating in a cell discontinuous transmission (DTX) mode or cell discontinuous reception (DRX) mode.

In some cases, a one or more UEs may be configured with periodic uplink resources in a CG configuration. In such cases, a UE may transmit an uplink transmission in a CG occasion without receiving a separate uplink grant. In cases where a UE has CG resources, a network entity may transmit an indication to the one or more UEs that it is activating a cell DRX mode and will not be monitoring during one or more CG occasions. In some cases, a UE may not successfully decode a cell DRX activation message (e.g., a UE may be subject to interference or channel fading and may not successfully decode a downlink control information (DCI) transmission that indicates cell DRX activation), and in such cases may continue to transmit a CG uplink transmission when the network entity is in the non-active mode. Such transmissions may result in increased power consumption, increased retransmissions, and increased latency in communications. Further, because the network entity is in the non-active state, it may not attempt to receive on the CG occasion in an non-active period, and will not transmit a negative acknowledgment that indicates the uplink transmission was not received, and thus retransmission of the uplink communication may be delayed until a higher layer identifies a missing the missing transmission. Thus, efficient techniques for confirming UE receipt of an activation DCI for a cell DRX configuration are desirable.

In accordance with various aspects discussed herein, techniques are provided in which an implicit or explicit indication of receipt of a cell DRX activation DCI are provided. In some aspects, a last CG transmission prior to a non-active period of a cell DRX configuration may include a skipping indication that indicates the UE will skip one or more CG uplink transmissions during the cell non-active period. In some aspects, the skipping indication may include a bitmap of CG occasions that indicate whether the occasions are skipped or not. In some cases, a same uplink control information (UCI) format that is used to indicate skipping to recycle uplink CG occasions for other UEs (e.g., when the UE does not have data to transmit in a CG occasion), may be used to indicate receipt of the activation DCI. In other cases, a different UCI format may be used to differentiate whether the skipping is for recycling of CG occasions or for DRX non-active periods. In further aspects, the indication of receipt of the cell DRX activation may be provided in an uplink reference signal (e.g., a sounding reference signal (SRS)), in which a first sequence may indicate that the cell DRX configuration is active, and a second sequence may indicate the cell DRX configuration is inactive. A network entity may monitor for UCI or an uplink reference signal and confirm that the UE has received the cell DRX activation DCI. In some aspects, in the event that the UE has not received the cell DRX activation DCI, the network entity may retransmit the cell DRX activation DCI, may defer entering the non-active mode, or any combinations thereof.

Various techniques as discussed herein may provide one or more UE and network enhancements and efficiencies. For example, a network entity may transition to a non-active mode and network power savings may be achieved. A UE may monitor for cell DTX/DRX activation messages, and may confirm receipt of such messages, which may enhance efficiency through reduced retransmissions and reduced latency in the event a cell DRX activation message is not successfully decoded. Thus, such techniques may provide for enhanced reliability and efficiency of communications links for communications when in a network energy savings mode.

Aspects of the disclosure are initially described in the context of wireless communications systems. Aspects of the disclosure are further illustrated by and described with reference to signaling diagrams, process flows, apparatus diagrams, system diagrams, and flowcharts that relate to techniques for confirmation of cell discontinuous transmission and reception activation.

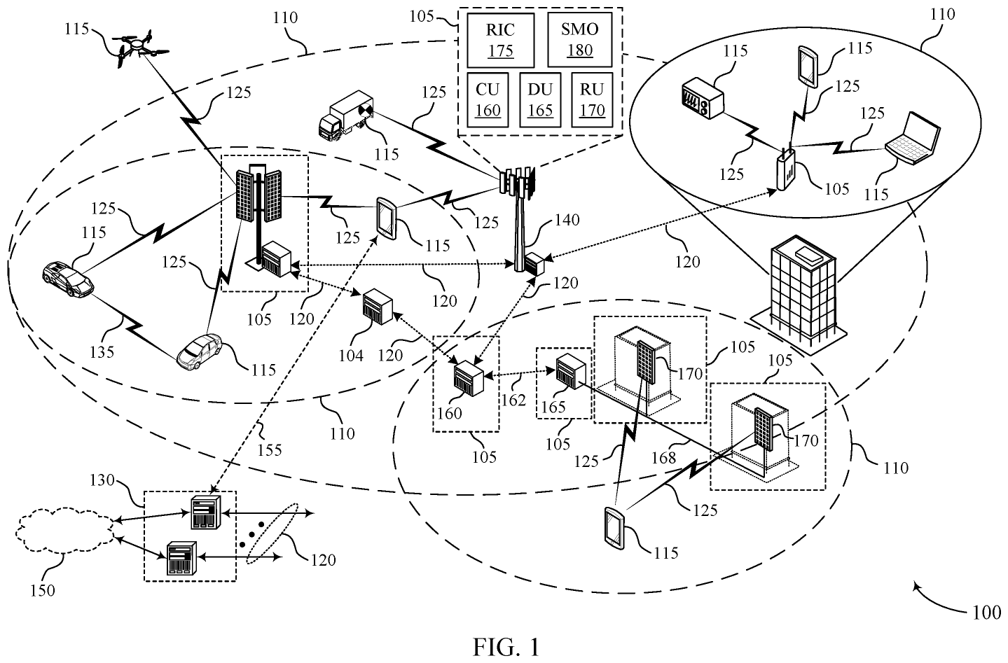

FIG. 1 shows an example of a wireless communications system 100 that supports techniques for confirmation of cell discontinuous transmission and reception activation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for confirmation of cell discontinuous transmission and reception activation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, one or more network entities 105 may enter into a cell DRX mode, and may transmit an activation DCI to one or more UEs 115 to indicate that the cell CRX mode is activated. In some aspects, a UE 115 may provide an implicit or explicit indication of receipt of the cell DRX activation DCI. In some aspects, a CG transmission prior to a non-active period of the cell DRX configuration may include a skipping indication that indicates the UE 115 will skip one or more CG uplink transmissions during the cell non-active period. In some aspects, the skipping indication may be provided in uplink control information (UCI) transmitted from a user equipment (UE). Additionally, or alternatively, the indication of receipt of the cell DRX activation may be provided in a reference signal (e.g., a SRS), in which a first reference signal sequence may indicate that the cell DRX configuration is active at the UE, and a second sequence may indicate the cell DRX configuration is not active at the UE.

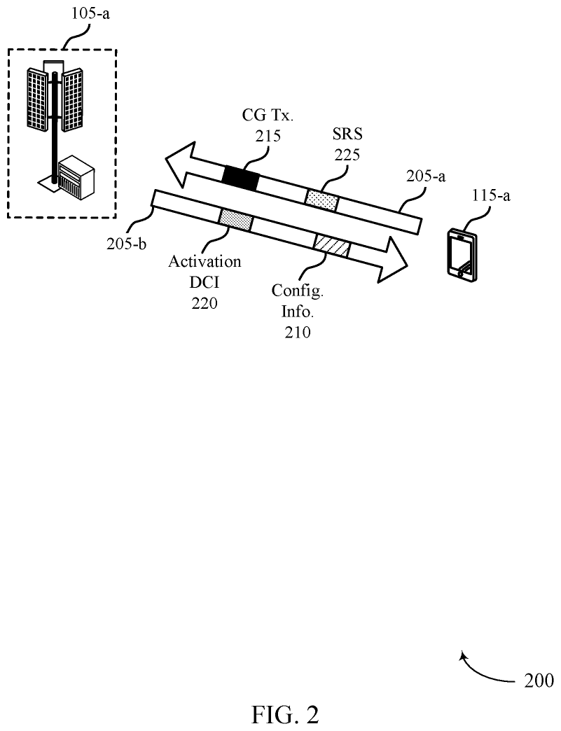

FIG. 2 shows an example of a wireless communications system 200 that supports techniques for confirmation of cell discontinuous transmission and reception activation in accordance with one or more aspects of the present disclosure. The wireless communications system 200 may implement or be implemented by aspects of the wireless communications system 100. For example, the wireless communications system 200 may include a network entity 105-a and a UE 115-a, which may be examples of a network entity 105 (e.g., an RU 170, a DU 165, a CU 160, a base station 140, or some combination thereof) and a UE 115 as described with reference to FIG. 1.

The network entity 105-a and the UE 115-a may communicate with one another via an uplink channel 205-a and a downlink channel 205-b, which may be examples or components of a communication link 125 as described with reference to FIG. 1. The UE 115-a and network entity 105-a may support techniques for confirmation of cell discontinuous transmission and reception activation through implicit or explicit indications of whether a cell DRX mode is active at the UE 115-a. By providing techniques for indicating whether cell DRX activation has been received at the UE 115-a, the UE 115-a and network entity 105-a may reduce a likelihood that the UE 115-a will transmit CG uplink transmissions while the network entity 105-a is in a non-active mode, which may promote resource efficiency, reduced latency, and enhanced reliability, while also providing for reduced power consumption for the wireless communications system 200.

In the example of FIG. 2, the network entity 105-a may transmit configuration information 210 to the UE 115-a. In some cases, the configuration information 210 may include CG information that provides configured uplink resources for periodic uplink transmissions from the UE 115-a. Further, in some cases the configuration information 210 may include information related to cell DRX and DTX configurations, with non-active and active mode periods. The configuration information, in some cases, may also configure the UE 115-a to provide an indication of whether an activation DCI 220 that activates the cell DRX/DTX mode has been received at the UE 115-a, in cases where the network entity 105-a is operating in an energy saving mode. In some aspects, the UE 115-a may transmit one or more CG uplink transmissions 215 to the network entity 105-a in accordance with the CG configuration. The network entity 105-a may initiate a cell DRX procedure at a cell (e.g., a SCell or PCell that is configured at the UE 115-a) based on the configuration information 210, and may transmit the cell DRX/DTX activation DCI 220, which may be received at UE 115-a.

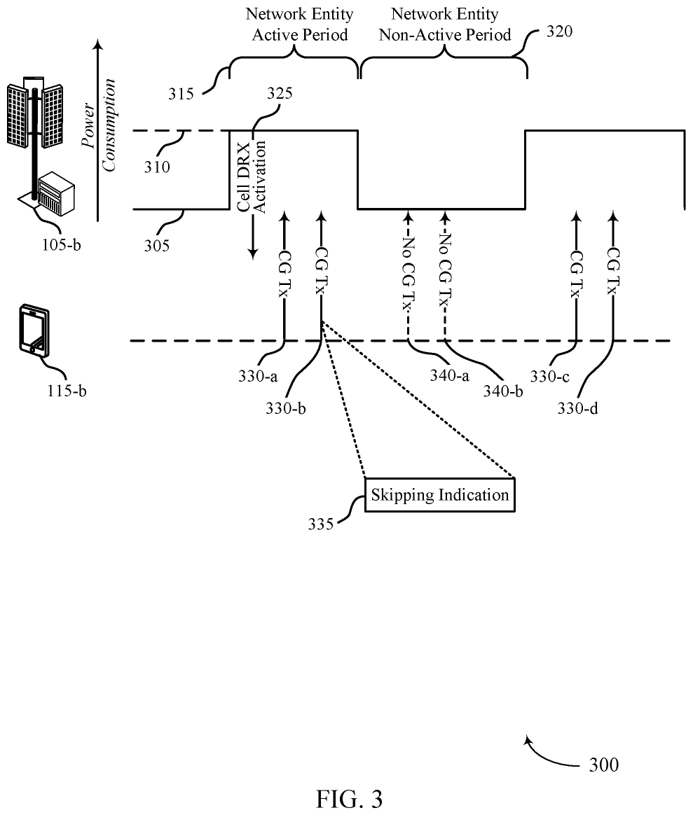

In accordance with various aspects discussed herein, when the UE 115-a is configured with cell DRX and when it is configured to transmit CG transmissions 215 that may overlap with cell DRX active and non-active time, the UE may provide an indication that the cell DRX/DTX activation DCI 220 has been successfully received at the UE 115-a. In some aspects, the UE 115-a may send a skipping indication along with the last occasion that falls within the cell DRX active time. The skipping indication may provide an indication for one or more CG occasions fall into a DRX non-active duration, for example. Using such techniques, if the UE 115-a miss-detects the activation DCI 220, the UE 115-a would be unaware of an upcoming non-active period, and would not send a skipping indication. If the network entity 105-a does not receive the skipping indication, it may be determined that the UE 115-a has not received the activation DCI 220 and is not aware that there is a non-active duration coming up. In some aspects, the network entity 105-a may take one or more actions to prevent the UE from wasting its energy (e.g., the network entity 105-a may retransmit the activation DCI 220, may defer entering a non-active mode, or both). In other aspects, additionally, or alternatively, the UE 115-a may transmit a SRS 225 that may indicate whether a cell DTX/DRX mode is active at the UE 115-a or not. In some cases, the SRS 225 may use a first reference signal sequence if cell DTX/DRX is active at the UE 115-a, and may use a second reference signal sequence if cell DRX/DRX is not active at the UE 115-a. In such cases, the network entity 105-a may identify whether the UE 115-a has received the cell DTX/DRX activation DCI 220 or not. Some examples of techniques for indicating whether the UE 115-a has received the activation DCI 220 are discussed with reference to FIGS. 3 through 6.

FIG. 3 shows an example of CG transmissions 300 that support techniques for confirmation of cell discontinuous transmission and reception activation in accordance with one or more aspects of the present disclosure. The CG transmissions 300 may be implemented by aspects of the wireless communications system 100 or 200. For example, a UE 115-b and network entity 105-b, which may be examples of UEs 115 and network entities 105 of FIGS. 1 and 2, may implement the CG transmissions 300. As discussed herein, network entity 105-b may transition between a non-active power consumption level 305 and an active power consumption level 310, in which the network entity 105-b has the active power consumption level 310 during active period 315 and has the non-active power consumption level 305 during non-active period 320.

In some aspects, the UE 115-b may have a CG configuration with periodic configured uplink resources for multiple CG occasions. In some cases, a cell DRX activation DCI 325 may be transmitted to the UE 115-b, that may indicate to the UE 115-b that one or more CG occasions may occur during the non-active period 320. In the example of FIG. 3, the UE 115-b may transmit a first CG transmission 330-a, and a second CG transmission 330-b prior to the network entity 105-b entering the non-active period 320. In accordance with various aspects, the second CG transmission 330-b (e.g., transmitted in a last CG occasion prior to the network entity 105-b entering the non-active period 320) may provide a skipping indication 335 that indicates the UE 115-b will skip a third CG transmission 340-a and a fourth CG transmission 340-b. In some cases, the network entity 105-b may return to the active mode and the UE 115-b may transmit a fifth CG transmission 330-c and a sixth CG transmission 330-d. In some cases, the cell DTX/DRX procedure may be enabled at the network entity 105-b based on traffic loads that are being served. For example, during certain hours (e.g., night hours in office areas) there may be relatively light traffic or no traffic for a cell, and the cell DTX/DRX procedure may help save network power and operational cost. In some cases, different DRX modes may be configured, where some DRX modes will turn off RF chains at the network entity 105-b while others may not, and thus different DRX modes have different power consumption.

In some aspects, the skipping indication 335 may use an unused transmission occasion (UTO) UCI or a different dedicated UCI that provides a UCI format for the skipping indication. In some aspects, the skipping indication 335 may include a bitmap of the CG occasions to be skipped, and in cases where the UE 115-b successfully receives the cell DRX activation DCI 325, the skipped CG occasions (e.g., corresponding to skipped third CG transmission 340-a and fourth CG transmission 340-b) are identified that are overlapping with the non-active period 320. In the event that the UE 115-b has not detected the cell DRX activation DCI 325, then the UE 115-b would not send the skipping indication 335, and the network entity 105-b may retransmit the cell DRX activation DCI 325, may defer entering the non-active mode in non-active period 320, or both.

In some aspects, the skipping indication 335 may distinguish skipping for the purpose of overlapping with the cell DRX non-active period 320 from skipping for the purpose of recycling CG transmit occasions to other UEs. For example, UCI transmissions with the different skipping indications may be disjoint, and may be configured by an RRC configuration that distinguishes the purpose for which different UCIs may be used. In such examples, if the UE 115-b wants to use the skipping indication for the purpose of recycling CG occasions for physical uplink shared channel (PUSCH) transmissions to other UEs while in the active period 315, then the UE may still do that and may also include in the skipping indication 335 the unused CG occasions overlapping with the cell DRX non-active period 320. In some cases, the skipping indication may provide a bitmap of CG occasions that are skipped and not skipped, and if the bitmap is inconsistent with the cell DRX non-active period 320 (e.g., if a CG occasion during non-active period 320 is not indicated as being skipped), the network entity 105-b may determine that the UE 115-b has not detected the cell DRX activation DCI 325. In other examples, the skipping indication 335 may be a one-bit flag in a dedicated UCI format that indicates that CG occasions during the non-active period 320 will be skipped. In some cases, UCI that provides the skipping indication 335 may be multiplexed on PUSCH, and the UCI may be given a higher priority because it is related to the reliability of detecting the cell DRX activation DCI 325 rather than indication of unused PUSCH occasions for purpose of recycling to other UEs.

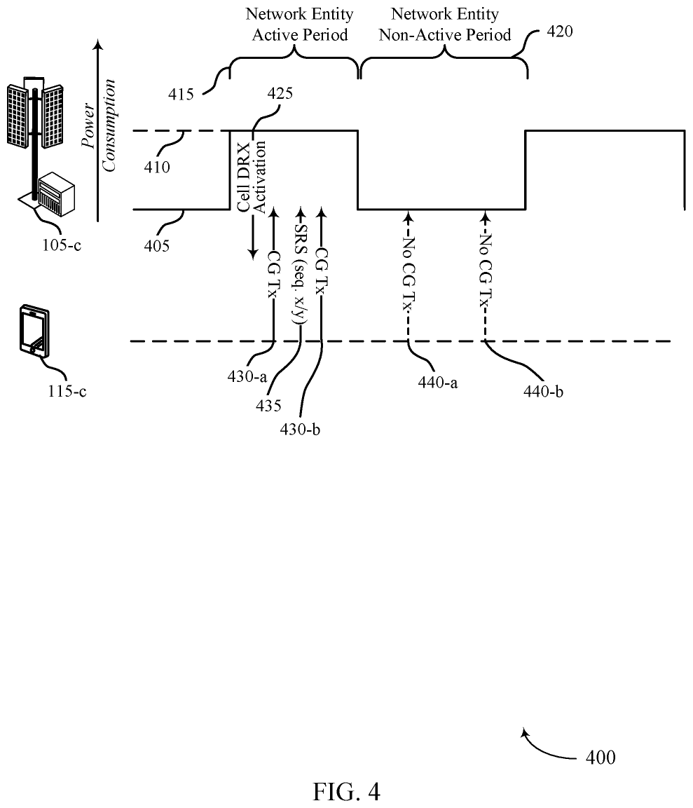

FIG. 4 shows an example of reference signal transmissions 400 that support techniques for confirmation of cell discontinuous transmission and reception activation in accordance with one or more aspects of the present disclosure. The reference signal transmissions 400 may be implemented by aspects of the wireless communications system 100 or 200. For example, a UE 115-c and network entity 105-c, which may be examples of UEs 115 and network entities 105 of FIGS. 1 through 3, may implement the reference signal transmissions 400. As discussed herein, network entity 105-c may transition between a non-active power consumption level 405 and an active power consumption level 410, in which the network entity 105-c has the active power consumption level 410 during active period 415 and has the non-active power consumption level 405 during non-active period 420.

In some aspects, the UE 115-c may have a CG configuration with periodic configured uplink resources for multiple CG occasions. In some cases, a cell DRX activation DCI 425 may be transmitted to the UE 115-c, that may indicate to the UE 115-c that one or more CG occasions may occur during the non-active period 420. In the example of FIG. 4, the UE 115-c may transmit a first CG transmission 430-a, and a second CG transmission 430-b prior to the network entity 105-c entering the non-active period 420. Further, the UE 115-c may transmit a first SRS 435 during the active period 415. In accordance with various aspects, the first SRS 435 may use a first reference signal sequence (e.g., sequence x) that may indicate that the UE 115-c identifies the network entity 105-c as having cell DRX activated, and may use a second reference signal sequence (e.g., sequence y) that may indicate that the UE 115-c identifies the network entity 105-c as not having cell DRX activated. Based on the SRS sequence of the SRS 435, the network entity 105-c may determine whether the UE 115-c successfully received the cell DRX activation DCI 425 or not. In some cases, the first reference signal sequence may use a first seed value for a reference signal pattern generation, and the second reference signal sequence may use a second seed value for the reference signal pattern generation, where the first seed and the second seed may be provided as part of the CG configuration, or separately configured (e.g., via RRC signaling). Based on the UE 115-c successfully receiving the cell DRX activation DCI 425, the UE 115-c may skip a third CG transmission 440-a and a fourth CG transmission 440-b that occur during the non-active period 420.

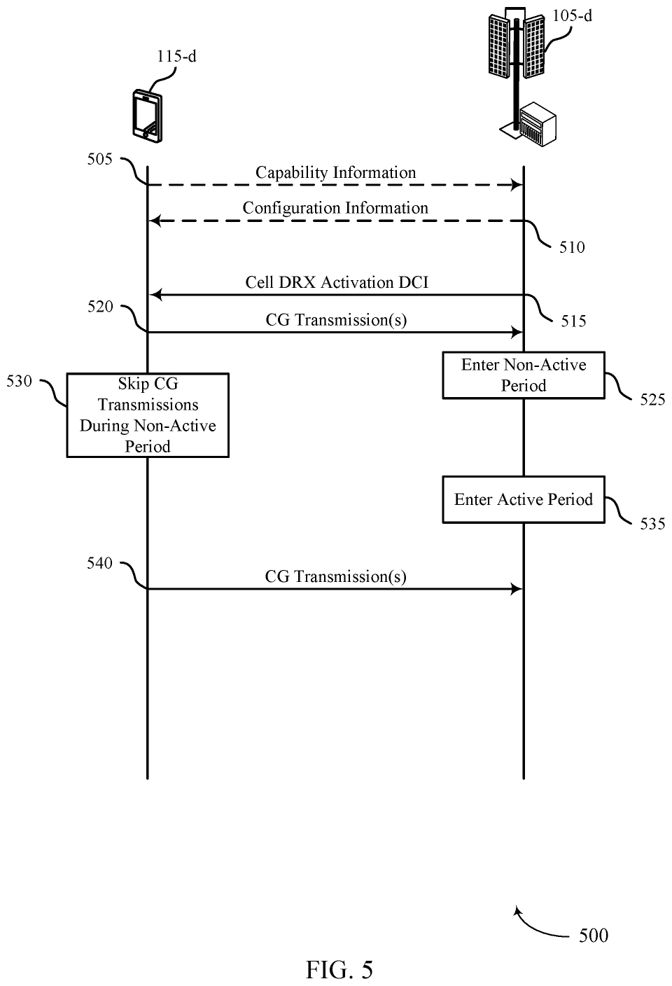

FIG. 5 shows an example of a process flow 500 that supports techniques for confirmation of cell discontinuous transmission and reception activation in accordance with one or more aspects of the present disclosure. The process flow 500 may include a network entity 105-d and a UE 115-d, which may be examples of a network entity 105 and a UE 115 as described with reference to FIGS. 1 through 4. The process flow 500 may be implemented by the network entity 105-d and the UE 115-d where a skipping indication from the UE 115-d provides an indication of successful receipt of a cell DRX activation DCI. Such techniques may provide for power savings at the network entity 105-d associated with a non-active mode, while also enabling confirmation that UE 115-d is aware of the non-active mode activation, which may thereby enhance overall network efficiency and user experience. In the following description of the process flow 500, the operations between the network entity 105-d and the UE 115-d may be performed in a different order than the example order shown. Some operations may be omitted from the process flow 500, and other operations may be added to the process flow 500.

At 505, optionally, the UE 115-d may transmit a capability information message that indicates to the network entity 105-d a capability for transmitting a CG skipping indication. In some cases, the capability information message may be transmitted via RRC signaling, one or more MAC-CEs, uplink control information (UCI), or any combinations thereof.

At 510, optionally, the network entity 105-d may transmit, and the UE 115-d may receive, configuration information associated with cell DRX/DTX modes. In some cases, the configuration information may include a CG configuration that provides CG resources for CG uplink transmissions from the UE 115-d. As discussed herein, such configuration information may provide characteristics of a cell DTX/DRX configuration, such as, for example, a duration of active periods and non-active periods, (e.g., a time duration or quantity of symbols/slots), a periodicity of non-active periods (e.g., time period, quantity of symbols/slots and symbol/slot offset), a frequency band or bandwidth part (BWP) that use non-active periods, or any combinations thereof. In some aspects, the configuration information may provide a mapping between different codepoints of a set of codepoints and different combinations active and non-active periods. In some cases, the configuration information may be provided via RRC signaling. In some cases, additionally, or alternatively, the configuration information may be provided with one or more system information transmissions (e.g., SIB/MIB transmissions), in one or more control channel transmissions (e.g., in DCI), and/or in one or more MAC-CE transmissions.

At 515, the network entity 105-d may transmit, and the UE 115-d may receive, a cell DRX activation DCI. As discussed herein, the cell DRX activation DCI may indicate that a cell associated with the network entity 105-d is transitioning to a non-active state. In some cases, the non-active state at the network entity 105-d may be a relatively low power mode at the network entity 105-d in which some or all transmit/receive components are powered down.

At 520, the UE 115-d may transmit, and the network entity 105-d may receive, one or more configured grant uplink transmissions. In some cases, the configured grant transmissions may be transmitted in accordance with the configured grant configuration that was provided to the UE 115-d. In some aspects, one or more of the configured grant transmissions may provide a skipping indication that may indicate the UE 115-d will skip one or more configured grant transmissions that would occur during a non-active period at the network entity 105-d. In some cases, the skipping indication may be provided in a UCI transmission (e.g., as a flag or a bitmap of CG occasions that are to be skipped). In some cases, the UCI may be multiplexed with a PUSCH transmission, and a priority may be set based on the UCI providing information related to communications reliability. In some cases, the network entity 105-d may monitor for the skipping indication and in the event that the skipping indication is not provided or does not indicate that the UE 115-d will skip one or more CG occasions that overlap with the non-active period, the network entity 105-d may take action to prevent the UE 115-d from transmitting while the network entity 105-d is in the non-active period (e.g., retransmit the cell DRX activation DCI, defer entering the non-active period, transmitting a configured grant deactivation message, and the like).

At 525, the network entity 105-d may enter a non-active period based on the cell DRX configuration. At 530, the UE 115-d may skip configured grant transmissions during the non-active period. At 535, the network entity 105-d may enter an active period, during which the UE 115-d, at 540, may transmit one or more additional configured grant transmissions.

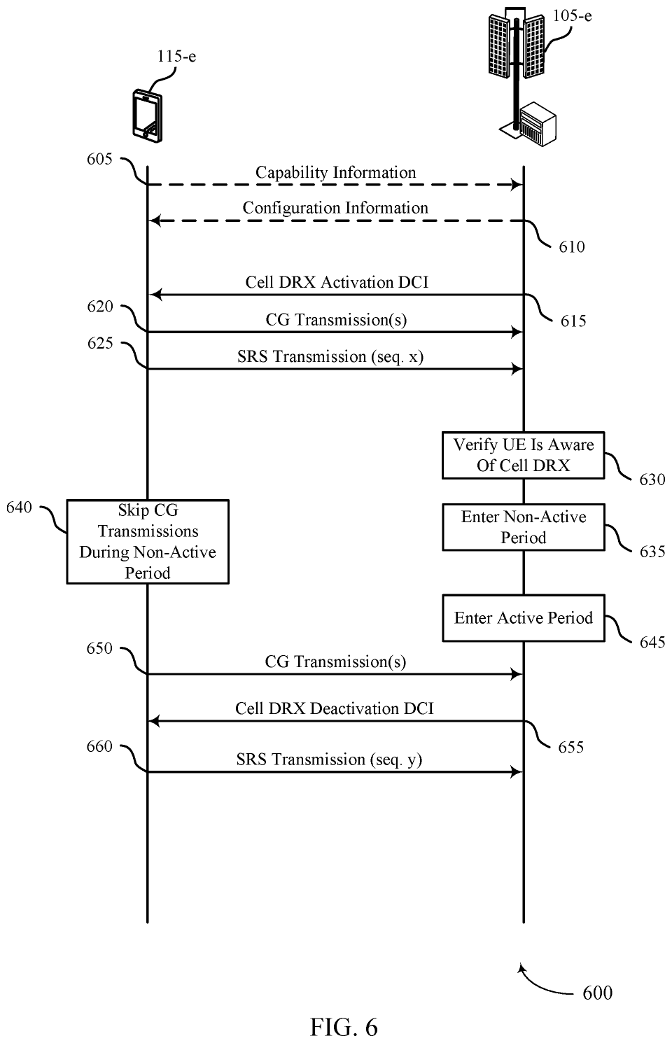

FIG. 6 shows an example of a process flow 600 that supports techniques for confirmation of cell discontinuous transmission and reception activation in accordance with one or more aspects of the present disclosure. The process flow 600 may include a network entity 105-e and a UE 115-e, which may be examples of a network entity 105 and a UE 115 as described with reference to FIGS. 1 through 5. The process flow 600 may be implemented by the network entity 105-e and the UE 115-e where a reference signal sequence of an uplink reference signal from the UE 115-e provides an indication of successful receipt of a cell DRX activation DCI. Such techniques may provide for power savings at the network entity 105-e associated with a non-active mode, while also enabling confirmation that UE 115-e is aware of the non-active mode activation, which may thereby enhance overall network efficiency and user experience. In the following description of the process flow 600, the operations between the network entity 105-e and the UE 115-e may be performed in a different order than the example order shown. Some operations may be omitted from the process flow 600, and other operations may be added to the process flow 600.

At 605, optionally, the UE 115-e may transmit a capability information message that indicates to the network entity 105-e a capability for transmitting uplink reference signals using different reference signal sequences based on whether a cell DTX/DRX mode is active or not. In some cases, the capability information message may be transmitted via RRC signaling, one or more MAC-CEs, UCI, or any combinations thereof.

At 610, optionally, the network entity 105-e may transmit, and the UE 115-e may receive, configuration information associated with cell DRX/DTX modes. In some cases, the configuration information may include a CG configuration that provides CG resources for CG uplink transmissions from the UE 115-e. As discussed herein, such configuration information may provide characteristics of a cell DTX/DRX configuration, such as, for example, a duration of active periods and non-active periods, (e.g., a time duration or quantity of symbols/slots), a periodicity of non-active periods (e.g., time period, quantity of symbols/slots and symbol/slot offset), a frequency band or bandwidth part (BWP) that use non-active periods, or any combinations thereof. In some aspects, the configuration information may provide a mapping between different codepoints of a set of codepoints and different combinations active and non-active periods. In some cases, the configuration information may be provided via RRC signaling. In some cases, additionally, or alternatively, the configuration information may be provided with one or more system information transmissions (e.g., SIB/MIB transmissions), in one or more control channel transmissions (e.g., in DCI), and/or in one or more MAC-CE transmissions.

At 615, the network entity 105-e may transmit, and the UE 115-e may receive, a cell DRX activation DCI. As discussed herein, the cell DRX activation DCI may indicate that a cell associated with the network entity 105-e is transitioning to a non-active state. In some cases, the non-active state at the network entity 105-e may be a relatively low power mode at the network entity 105-e in which some or all transmit/receive components are powered down.

At 620, the UE 115-e may transmit, and the network entity 105-e may receive, one or more configured grant uplink transmissions. In some cases, the configured grant transmissions may be transmitted in accordance with the configured grant configuration that was provided to the UE 115-e.

At 625, the UE 115-e may transmit, and the network entity 105-e may receive, a SRS transmission. In accordance with various aspects discussed herein, the SRS transmission may use a first sequence (e.g., generated from a first seed that is provided with the configuration information) that indicates the UE 115-e identifies that the network entity 105-e is in a cell DRX/DTX active mode.

At 630, the network entity 105-e may monitor for the SRS and verify that the UE 115-e is aware of the cell DRX/DTX activation. In the event that the reference signal sequence corresponds to the cell DRX/DTX active mode, the network entity 105-e may continue operation in the cell DRX/DTX mode. In the event that reference signal sequence corresponds to the cell DRX/DTX normal operation mode (e.g., cell DRX is not active), the network entity 105-e may identify that the cell DRX activation DCI was not received at the UE 115-e, and may take action to prevent the UE 115-e from transmitting while the network entity 105-e is in the non-active period (e.g., retransmit the cell DRX activation DCI, defer entering the non-active period, transmitting a configured grant deactivation message, and the like).

At 635, the network entity 105-e may enter a non-active period based on the cell DRX configuration. At 640, the UE 115-e may skip configured grant transmissions during the non-active period. At 645, the network entity 105-e may enter an active period, during which the UE 115-e, at 650, may transmit one or more additional configured grant transmissions.

In the example of FIG. 6, at 655, the network entity 105-e may transmit, and the UE 115-e may receive, a cell DRX deactivation DCI. The cell DRX deactivation DCI may indicate that a cell associated with the network entity 105-e is transitioning out of the cell DRX/DTX mode, and into a normal mode with no non-active periods. At 660, the UE 115-e may transmit, and the network entity 105-e may receive, a second SRS transmission. In accordance with various aspects discussed herein, the second SRS transmission may use a second sequence (e.g., generated from a second seed that is provided with the configuration information) that indicates the UE 115-e identifies that the network entity 105-e is not in a cell DRX/DTX active mode.

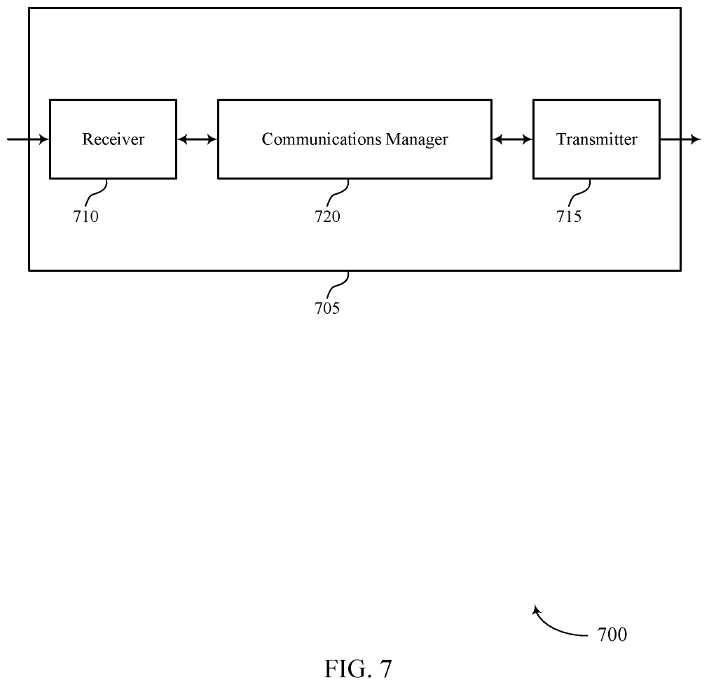

FIG. 7 shows a block diagram 700 of a device 705 that supports techniques for confirmation of cell discontinuous transmission and reception activation in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for confirmation of cell discontinuous transmission and reception activation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for confirmation of cell discontinuous transmission and reception activation). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for confirmation of cell discontinuous transmission and reception activation as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving configuration information for a cell discontinuous reception configuration that indicates one or more cell non-active periods during which a serving cell does not monitor for communications from the UE. The communications manager 720 is capable of, configured to, or operable to support a means for receiving an activation message that activates the cell discontinuous reception configuration. The communications manager 720 is capable of, configured to, or operable to support a means for transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

Additionally, or alternatively, the communications manager 720 may support wireless communications in accordance with examples as disclosed herein. For example, the communications manager 720 is capable of, configured to, or operable to support a means for receiving configuration information for a cell discontinuous reception configuration that indicates one or more cell non-active periods during which a serving cell does not monitor for communications from the UE. The communications manager 720 is capable of, configured to, or operable to support a means for receiving an activation message that activates the cell discontinuous reception configuration. The communications manager 720 is capable of, configured to, or operable to support a means for transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for UE confirmation of a cell DTX/DRX mode activation, which may reduce a likelihood that a UE will transmit CG uplink transmissions while a network entity is in a non-active mode, and may thereby promote resource efficiency, reduced latency, and enhanced reliability, while also providing for reduced power consumption.

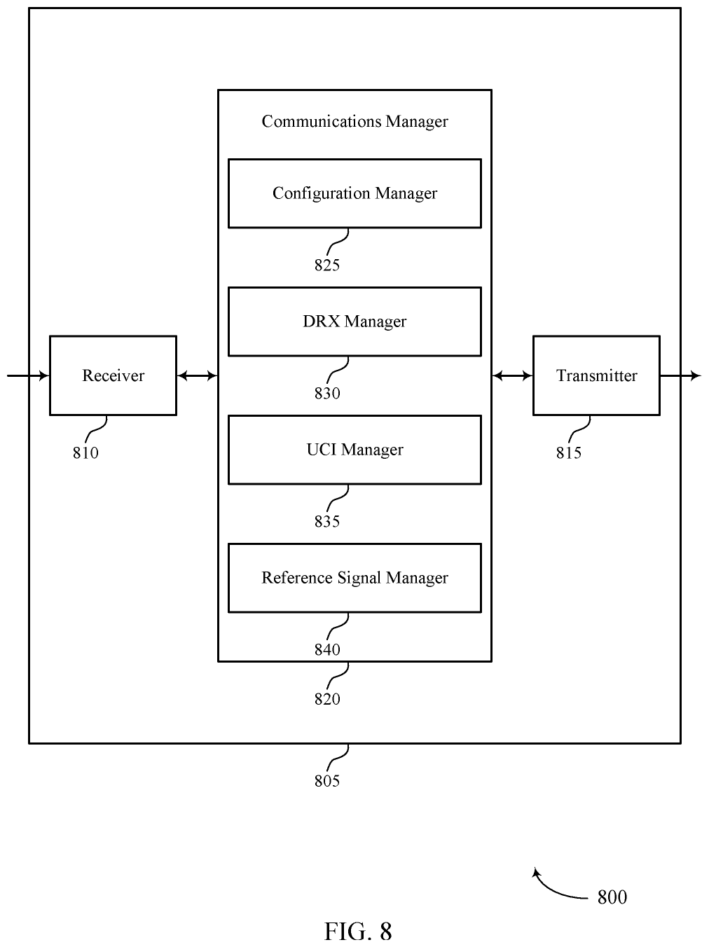

FIG. 8 shows a block diagram 800 of a device 805 that supports techniques for confirmation of cell discontinuous transmission and reception activation in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for confirmation of cell discontinuous transmission and reception activation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for confirmation of cell discontinuous transmission and reception activation). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for confirmation of cell discontinuous transmission and reception activation as described herein. For example, the communications manager 820 may include a configuration manager 825, a DRX manager 830, a UCI manager 835, a reference signal manager 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration manager 825 is capable of, configured to, or operable to support a means for receiving configuration information for a cell discontinuous reception configuration that indicates one or more cell non-active periods during which a serving cell does not monitor for communications from the UE. The DRX manager 830 is capable of, configured to, or operable to support a means for receiving an activation message that activates the cell discontinuous reception configuration. The UCI manager 835 is capable of, configured to, or operable to support a means for transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

Additionally, or alternatively, the communications manager 820 may support wireless communications in accordance with examples as disclosed herein. The configuration manager 825 is capable of, configured to, or operable to support a means for receiving configuration information for a cell discontinuous reception configuration that indicates one or more cell non-active periods during which a serving cell does not monitor for communications from the UE. The DRX manager 830 is capable of, configured to, or operable to support a means for receiving an activation message that activates the cell discontinuous reception configuration. The reference signal manager 840 is capable of, configured to, or operable to support a means for transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

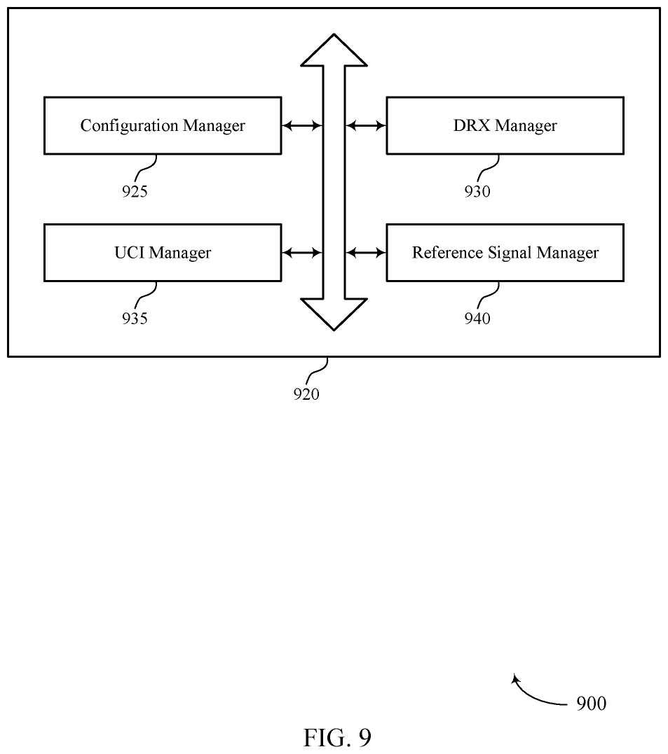

FIG. 9 shows a block diagram 900 of a communications manager 920 that supports techniques for confirmation of cell discontinuous transmission and reception activation in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for confirmation of cell discontinuous transmission and reception activation as described herein. For example, the communications manager 920 may include a configuration manager 925, a DRX manager 930, a UCI manager 935, a reference signal manager 940, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration manager 925 is capable of, configured to, or operable to support a means for receiving configuration information for a cell discontinuous reception configuration that indicates one or more cell non-active periods during which a serving cell does not monitor for communications from the UE. The DRX manager 930 is capable of, configured to, or operable to support a means for receiving an activation message that activates the cell discontinuous reception configuration. The UCI manager 935 is capable of, configured to, or operable to support a means for transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE. In some examples, the first uplink transmission is transmitted in a last configured grant resource allocation within a cell active period prior to the first cell non-active period.

In some examples, the DRX manager 930 is capable of, configured to, or operable to support a means for determining the one or more configured grant occasions that overlap with the first cell non-active period, and where the skipping indication identifies each of the one or more configured grant occasions that overlap with the first cell non-active period.

In some examples, the UCI manager 935 is capable of, configured to, or operable to support a means for transmitting, subsequent to a deactivation of the cell discontinuous reception configuration, a second uplink transmission in accordance with the configured grant resource allocation, where the second uplink transmission does not include the skipping indication and signals that a subsequent activation message that activates the cell discontinuous reception configuration has not been received at the UE.

In some examples, the skipping indication is provided in UCI included with the first uplink transmission. In some examples, the skipping indication includes a bitmap of the one or more configured grant occasions that overlap with the first cell non-active period. In some examples, the UCI has a same UCI format as a first UCI format that indicates skipping at the UE due to a lack of data to transmit, or has a different UCI format than the first UCI format. In some examples, the skipping indication provides both the confirmation that the activation message was successfully received at the UE and an indication that one or more configured grant occasions that overlap with a cell active period are to be skipped. In some examples, the skipping indication includes a bitmap of the one or more configured grant occasions that overlap with the first cell non-active period and the cell active period.

In some examples, to support transmitting the first uplink transmission, the UCI manager 935 is capable of, configured to, or operable to support a means for multiplexing uplink control information (UCI) that includes the skipping indication with a physical uplink shared channel transmission that is included in the first uplink transmission, and where the UCI has a higher priority than other UCI that indicates only that one or more configured grant occasions that overlap with a cell active period are to be skipped.

Additionally, or alternatively, the communications manager 920 may support wireless communications in accordance with examples as disclosed herein. In some examples, the configuration manager 925 is capable of, configured to, or operable to support a means for receiving configuration information for a cell discontinuous reception configuration that indicates one or more cell non-active periods during which a serving cell does not monitor for communications from the UE. In some examples, the DRX manager 930 is capable of, configured to, or operable to support a means for receiving an activation message that activates the cell discontinuous reception configuration. The reference signal manager 940 is capable of, configured to, or operable to support a means for transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

In some examples, the reference signal manager 940 is capable of, configured to, or operable to support a means for selecting the first reference signal sequence for an uplink sounding reference signal based on successful receipt of the activation message, and where the second reference signal sequence is selected for the uplink sounding reference signal when the activation message that activates the cell discontinuous reception configuration is not received at the UE. In some examples, the first reference signal sequence is determined based on a first seed value for reference signal generation, and the second reference signal sequence is determined based on a second seed value for reference signal generation.

In some examples, the reference signal manager 940 is capable of, configured to, or operable to support a means for transmitting, subsequent to a deactivation of the cell discontinuous reception configuration, a second uplink reference signal including the second reference signal sequence, where the second reference signal sequence indicates that a subsequent activation message that activates the cell discontinuous reception configuration has not been received at the UE. In some examples, the first uplink reference signal and the second uplink reference signal are sounding reference signals.

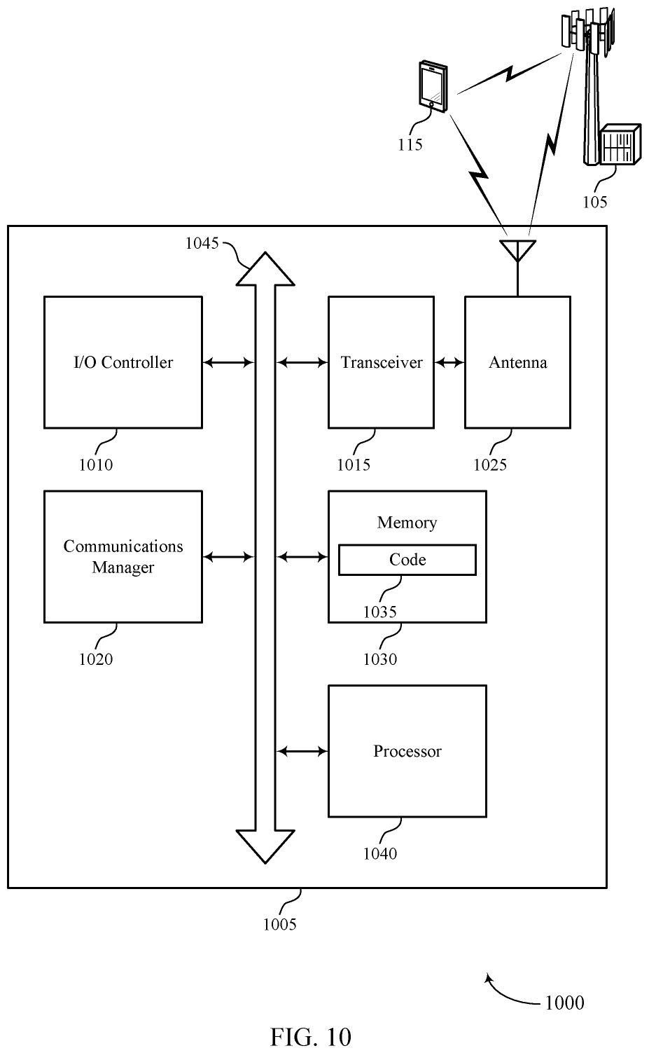

FIG. 10 shows a diagram of a system 1000 including a device 1005 that supports techniques for confirmation of cell discontinuous transmission and reception activation in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for confirmation of cell discontinuous transmission and reception activation). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving configuration information for a cell discontinuous reception configuration that indicates one or more cell non-active periods during which a serving cell does not monitor for communications from the UE. The communications manager 1020 is capable of, configured to, or operable to support a means for receiving an activation message that activates the cell discontinuous reception configuration. The communications manager 1020 is capable of, configured to, or operable to support a means for transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

Additionally, or alternatively, the communications manager 1020 may support wireless communications in accordance with examples as disclosed herein. For example, the communications manager 1020 is capable of, configured to, or operable to support a means for receiving configuration information for a cell discontinuous reception configuration that indicates one or more cell non-active periods during which a serving cell does not monitor for communications from the UE. The communications manager 1020 is capable of, configured to, or operable to support a means for receiving an activation message that activates the cell discontinuous reception configuration. The communications manager 1020 is capable of, configured to, or operable to support a means for transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

By including or configuring the communications manager 1020 in accordance with examples as described herein, the device 1005 may support techniques for UE confirmation of a cell DTX/DRX mode activation, which may reduce a likelihood that a UE will transmit CG uplink transmissions while a network entity is in a non-active mode, and may thereby promote resource efficiency, reduced latency, and enhanced reliability, while also providing for reduced power consumption.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for confirmation of cell discontinuous transmission and reception activation as described herein, or the at least one processor 1040 and the at least one memory 1030 may be otherwise configured to, individually or collectively, perform or support such operations.

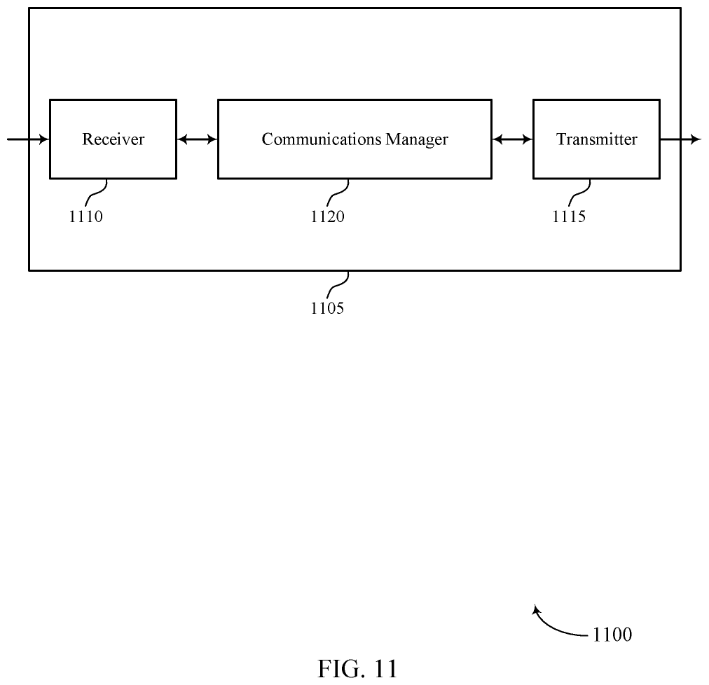

FIG. 11 shows a block diagram 1100 of a device 1105 that supports techniques for confirmation of cell discontinuous transmission and reception activation in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for confirmation of cell discontinuous transmission and reception activation as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting, to a UE, configuration information for a cell discontinuous reception configuration that indicates one or more cell non-active periods during which a serving cell associated with the network entity does not monitor for communications from the UE. The communications manager 1120 is capable of, configured to, or operable to support a means for transmitting, to the UE, an activation message that activates the cell discontinuous reception configuration. The communications manager 1120 is capable of, configured to, or operable to support a means for receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

Additionally, or alternatively, the communications manager 1120 may support wireless communications in accordance with examples as disclosed herein. For example, the communications manager 1120 is capable of, configured to, or operable to support a means for transmitting, to a UE, configuration information for a cell discontinuous reception configuration that indicates one or more cell non-active periods during which a serving cell associated with the network entity does not monitor for communications from the UE. The communications manager 1120 is capable of, configured to, or operable to support a means for transmitting, to the UE, an activation message that activates the cell discontinuous reception configuration. The communications manager 1120 is capable of, configured to, or operable to support a means for receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for UE confirmation of a cell DTX/DRX mode activation, which may reduce a likelihood that a UE will transmit CG uplink transmissions while a network entity is in a non-active mode, and may thereby promote resource efficiency, reduced latency, and enhanced reliability, while also providing for reduced power consumption.

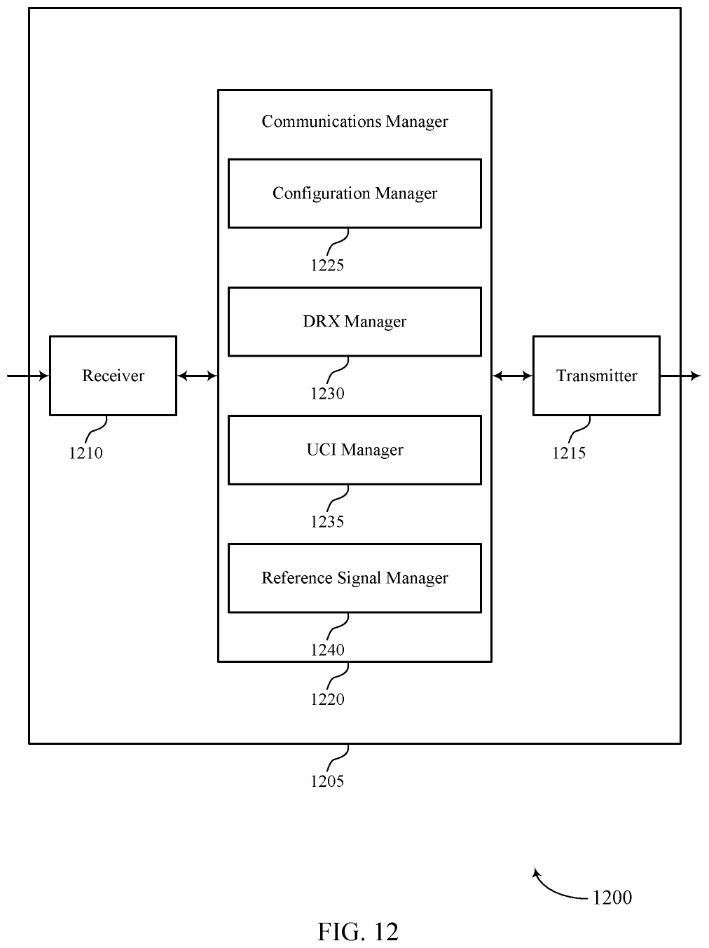

FIG. 12 shows a block diagram 1200 of a device 1205 that supports techniques for confirmation of cell discontinuous transmission and reception activation in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for confirmation of cell discontinuous transmission and reception activation as described herein. For example, the communications manager 1220 may include a configuration manager 1225, a DRX manager 1230, a UCI manager 1235, a reference signal manager 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration manager 1225 is capable of, configured to, or operable to support a means for transmitting, to a UE, configuration information for a cell discontinuous reception configuration that indicates one or more cell non-active periods during which a serving cell associated with the network entity does not monitor for communications from the UE. The DRX manager 1230 is capable of, configured to, or operable to support a means for transmitting, to the UE, an activation message that activates the cell discontinuous reception configuration. The UCI manager 1235 is capable of, configured to, or operable to support a means for receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

Additionally, or alternatively, the communications manager 1220 may support wireless communications in accordance with examples as disclosed herein. The configuration manager 1225 is capable of, configured to, or operable to support a means for transmitting, to a UE, configuration information for a cell discontinuous reception configuration that indicates one or more cell non-active periods during which a serving cell associated with the network entity does not monitor for communications from the UE. The DRX manager 1230 is capable of, configured to, or operable to support a means for transmitting, to the UE, an activation message that activates the cell discontinuous reception configuration. The reference signal manager 1240 is capable of, configured to, or operable to support a means for receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active.

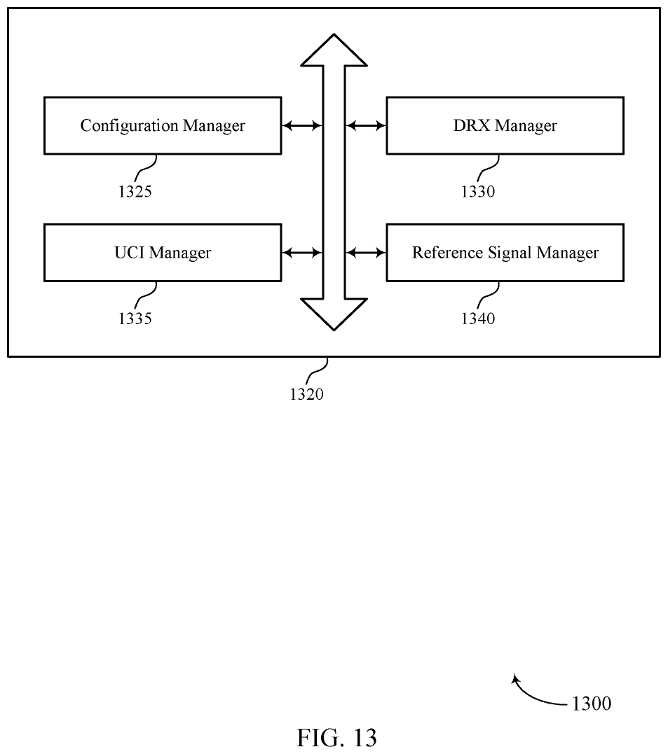

FIG. 13 shows a block diagram 1300 of a communications manager 1320 that supports techniques for confirmation of cell discontinuous transmission and reception activation in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for confirmation of cell discontinuous transmission and reception activation as described herein. For example, the communications manager 1320 may include a configuration manager 1325, a DRX manager 1330, a UCI manager 1335, a reference signal manager 1340, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration manager 1325 is capable of, configured to, or operable to support a means for transmitting, to a UE, configuration information for a cell discontinuous reception configuration that indicates one or more cell non-active periods during which a serving cell associated with the network entity does not monitor for communications from the UE. The DRX manager 1330 is capable of, configured to, or operable to support a means for transmitting, to the UE, an activation message that activates the cell discontinuous reception configuration. The UCI manager 1335 is capable of, configured to, or operable to support a means for receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE. In some examples, the first uplink transmission is transmitted in a last configured grant resource allocation within a cell active period prior to the first cell non-active period. In some examples, the skipping indication identifies each of the one or more configured grant occasions that overlap with the first cell non-active period.

In some examples, the DRX manager 1330 is capable of, configured to, or operable to support a means for transmitting, subsequent to a deactivation of the cell discontinuous reception configuration, a second activation message that re-activates the cell discontinuous reception configuration. In some examples, the UCI manager 1335 is capable of, configured to, or operable to support a means for receiving, from the UE, a second uplink transmission in accordance with the configured grant resource allocation, where the second uplink transmission does not include the skipping indication. In some examples, the DRX manager 1330 is capable of, configured to, or operable to support a means for determining that the UE did not receive the second activation message.

In some examples, the skipping indication is provided in UCI included with the first uplink transmission. In some examples, the skipping indication includes a bitmap of the one or more configured grant occasions that overlap with the first cell non-active period. In some examples, the UCI has a same UCI format as a first UCI format that indicates skipping at the UE due to a lack of data to transmit, or has a different UCI format than the first UCI format. In some examples, the skipping indication provides both the confirmation that the activation message was successfully received at the UE and an indication that one or more configured grant occasions that overlap with a cell active period are to be skipped. In some examples, the skipping indication includes a bitmap of the one or more configured grant occasions that overlap with the first cell non-active period and the cell active period.

In some examples, to support receiving the first uplink transmission, the UCI manager 1335 is capable of, configured to, or operable to support a means for demultiplexing uplink control information (UCI) that includes the skipping indication and a physical uplink shared channel transmission that is included in the first uplink transmission, and where the UCI has a higher priority than other UCI that indicates only that one or more configured grant occasions that overlap with a cell active period are to be skipped.

Additionally, or alternatively, the communications manager 1320 may support wireless communications in accordance with examples as disclosed herein. In some examples, the configuration manager 1325 is capable of, configured to, or operable to support a means for transmitting, to a UE, configuration information for a cell discontinuous reception configuration that indicates one or more cell non-active periods during which a serving cell associated with the network entity does not monitor for communications from the UE. In some examples, the DRX manager 1330 is capable of, configured to, or operable to support a means for transmitting, to the UE, an activation message that activates the cell discontinuous reception configuration. The reference signal manager 1340 is capable of, configured to, or operable to support a means for receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active. In some examples, the first reference signal sequence is provided in an uplink sounding reference signal and indicates successful receipt of the activation message, and the second reference signal sequence is provided in the uplink sounding reference signal when the activation message is not successfully decoded at the UE. In some examples, the first reference signal sequence is determined based on a first seed value for reference signal generation, and the second reference signal sequence is determined based on a second seed value for reference signal generation.

In some examples, the DRX manager 1330 is capable of, configured to, or operable to support a means for transmitting, subsequent to a deactivation of the cell discontinuous reception configuration, a second activation message that re-activates the cell discontinuous reception configuration. In some examples, the reference signal manager 1340 is capable of, configured to, or operable to support a means for receiving, from the UE, a second uplink reference signal including the second reference signal sequence. In some examples, the DRX manager 1330 is capable of, configured to, or operable to support a means for determining that the UE did not receive the second activation message. In some examples, the first uplink reference signal and the second uplink reference signal are sounding reference signals.

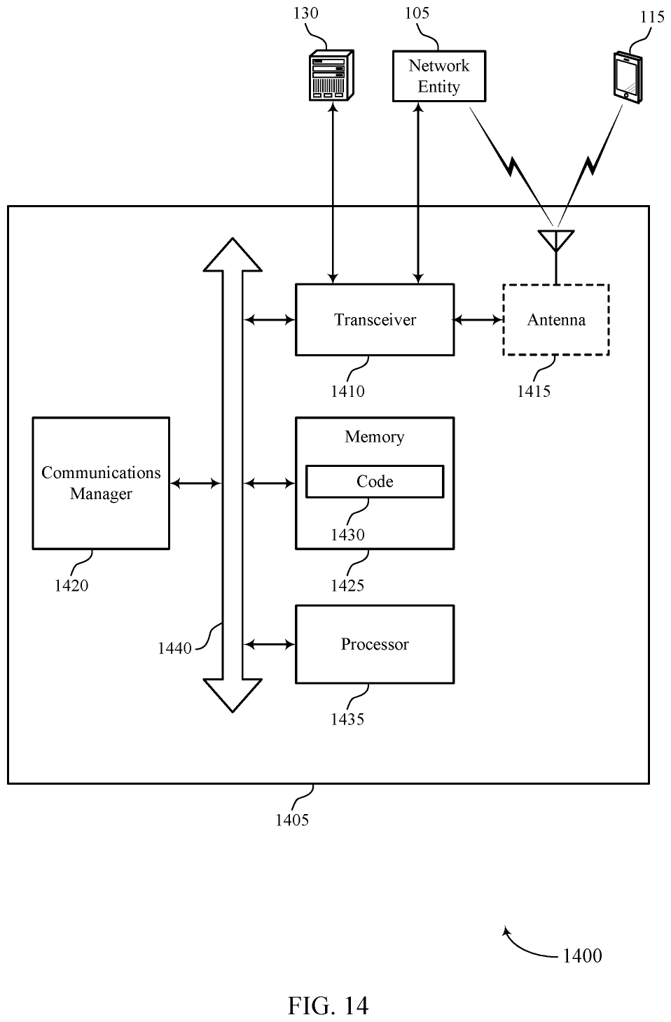

FIG. 14 shows a diagram of a system 1400 including a device 1405 that supports techniques for confirmation of cell discontinuous transmission and reception activation in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for confirmation of cell discontinuous transmission and reception activation). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting, to a UE, configuration information for a cell discontinuous reception configuration that indicates one or more cell non-active periods during which a serving cell associated with the network entity does not monitor for communications from the UE. The communications manager 1420 is capable of, configured to, or operable to support a means for transmitting, to the UE, an activation message that activates the cell discontinuous reception configuration. The communications manager 1420 is capable of, configured to, or operable to support a means for receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE.

Additionally, or alternatively, the communications manager 1420 may support wireless communications in accordance with examples as disclosed herein. For example, the communications manager 1420 is capable of, configured to, or operable to support a means for transmitting, to a UE, configuration information for a cell discontinuous reception configuration that indicates one or more cell non-active periods during which a serving cell associated with the network entity does not monitor for communications from the UE. The communications manager 1420 is capable of, configured to, or operable to support a means for transmitting, to the UE, an activation message that activates the cell discontinuous reception configuration. The communications manager 1420 is capable of, configured to, or operable to support a means for receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active.

By including or configuring the communications manager 1420 in accordance with examples as described herein, the device 1405 may support techniques for UE confirmation of a cell DTX/DRX mode activation, which may reduce a likelihood that a UE will transmit CG uplink transmissions while a network entity is in a non-active mode, and may thereby promote resource efficiency, reduced latency, and enhanced reliability, while also providing for reduced power consumption.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for confirmation of cell discontinuous transmission and reception activation as described herein, or the at least one processor 1435 and the at least one memory 1425 may be otherwise configured to, individually or collectively, perform or support such operations.

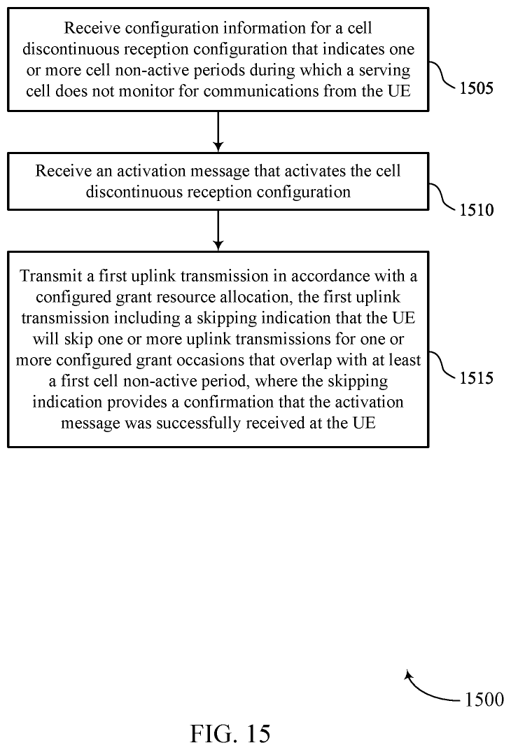

FIG. 15 shows a flowchart illustrating a method 1500 that supports techniques for confirmation of cell discontinuous transmission and reception activation in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving configuration information for a cell discontinuous reception configuration that indicates one or more cell non-active periods during which a serving cell does not monitor for communications from the UE. The operations of block 1505 may be performed in accordance with examples as disclosed herein. In some examples, aspects of the operations of 1505 may be performed by a configuration manager 925 as described with reference to FIG. 9.

At 1510, the method may include receiving an activation message that activates the cell discontinuous reception configuration. The operations of block 1510 may be performed in accordance with examples as disclosed herein. In some examples, aspects of the operations of 1510 may be performed by a DRX manager 930 as described with reference to FIG. 9.

At 1515, the method may include transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE. The operations of block 1515 may be performed in accordance with examples as disclosed herein. In some examples, aspects of the operations of 1515 may be performed by a UCI manager 935 as described with reference to FIG. 9.

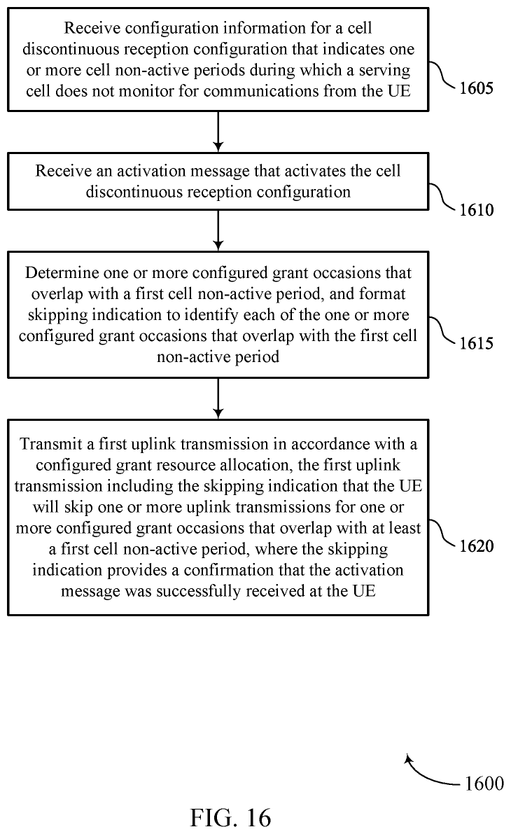

FIG. 16 shows a flowchart illustrating a method 1600 that supports techniques for confirmation of cell discontinuous transmission and reception activation in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving configuration information for a cell discontinuous reception configuration that indicates one or more cell non-active periods during which a serving cell does not monitor for communications from the UE. The operations of block 1605 may be performed in accordance with examples as disclosed herein. In some examples, aspects of the operations of 1605 may be performed by a configuration manager 925 as described with reference to FIG. 9.

At 1610, the method may include receiving an activation message that activates the cell discontinuous reception configuration. The operations of block 1610 may be performed in accordance with examples as disclosed herein. In some examples, aspects of the operations of 1610 may be performed by a DRX manager 930 as described with reference to FIG. 9.

At 1615, the method may include determining one or more configured grant occasions that overlap with the first cell non-active period, and formatting a skipping indication to identify each of the one or more configured grant occasions that overlap with the first cell non-active period. The operations of block 1615 may be performed in accordance with examples as disclosed herein. In some examples, aspects of the operations of 1615 may be performed by a DRX manager 930 as described with reference to FIG. 9.

At 1620, the method may include transmitting a first uplink transmission in accordance with a configured grant resource allocation, the first uplink transmission including the skipping indication that the UE will skip one or more uplink transmissions for one or more configured grant occasions that overlap with at least a first cell non-active period, where the skipping indication provides a confirmation that the activation message was successfully received at the UE. The operations of block 1620 may be performed in accordance with examples as disclosed herein. In some examples, aspects of the operations of 1620 may be performed by a UCI manager 935 as described with reference to FIG. 9.

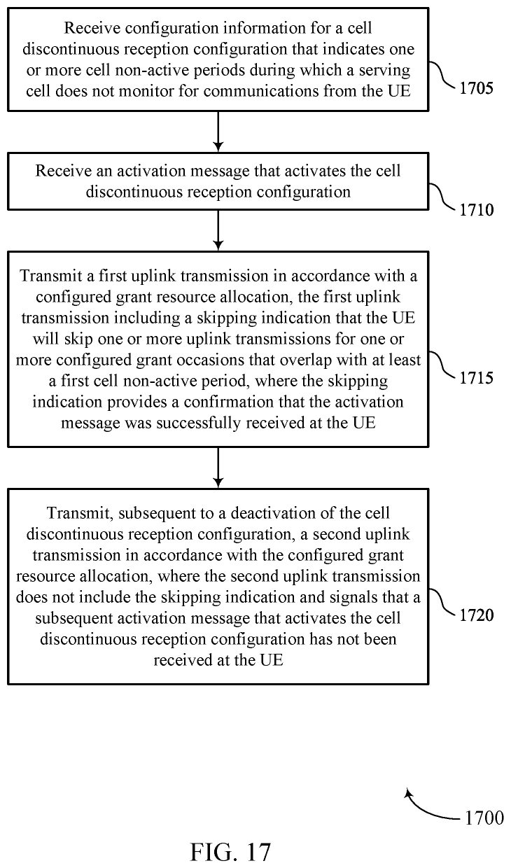

FIG. 17 shows a flowchart illustrating a method 1700 that supports techniques for confirmation of cell discontinuous transmission and reception activation in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving configuration information for a cell discontinuous reception configuration that indicates one or more cell non-active periods during which a serving cell does not monitor for communications from the UE. The operations of block 1705 may be performed in accordance with examples as disclosed herein. In some examples, aspects of the operations of 1705 may be performed by a configuration manager 925 as described with reference to FIG. 9.

At 1710, the method may include receiving an activation message that activates the cell discontinuous reception configuration. The operations of block 1710 may be performed in accordance with examples as disclosed herein. In some examples, aspects of the operations of 1710 may be performed by a DRX manager 930 as described with reference to FIG. 9.

At 1715, the method may include transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE. The operations of block 1715 may be performed in accordance with examples as disclosed herein. In some examples, aspects of the operations of 1715 may be performed by a UCI manager 935 as described with reference to FIG. 9.

At 1720, the method may include transmitting, subsequent to a deactivation of the cell discontinuous reception configuration, a second uplink transmission in accordance with the configured grant resource allocation, where the second uplink transmission does not include the skipping indication and signals that a subsequent activation message that activates the cell discontinuous reception configuration has not been received at the UE. The operations of block 1720 may be performed in accordance with examples as disclosed herein. In some examples, aspects of the operations of 1720 may be performed by a UCI manager 935 as described with reference to FIG. 9.

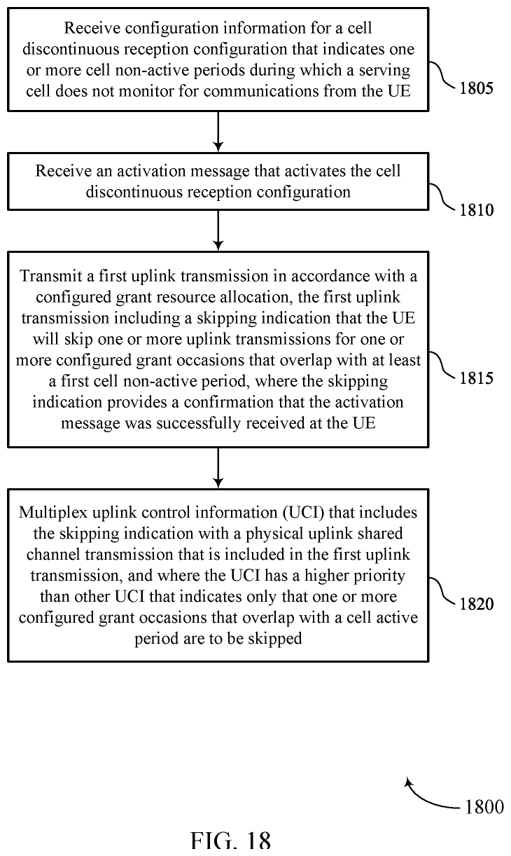

FIG. 18 shows a flowchart illustrating a method 1800 that supports techniques for confirmation of cell discontinuous transmission and reception activation in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving configuration information for a cell discontinuous reception configuration that indicates one or more cell non-active periods during which a serving cell does not monitor for communications from the UE. The operations of block 1805 may be performed in accordance with examples as disclosed herein. In some examples, aspects of the operations of 1805 may be performed by a configuration manager 925 as described with reference to FIG. 9.

At 1810, the method may include receiving an activation message that activates the cell discontinuous reception configuration. The operations of block 1810 may be performed in accordance with examples as disclosed herein. In some examples, aspects of the operations of 1810 may be performed by a DRX manager 930 as described with reference to FIG. 9.

At 1815, the method may include transmitting a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE. The operations of block 1815 may be performed in accordance with examples as disclosed herein. In some examples, aspects of the operations of 1815 may be performed by a UCI manager 935 as described with reference to FIG. 9.

At 1820, the method may include, as part of transmitting the first uplink transmission, multiplexing uplink control information (UCI) that includes the skipping indication with a physical uplink shared channel transmission that is included in the first uplink transmission, and where the UCI has a higher priority than other UCI that indicates only that one or more configured grant occasions that overlap with a cell active period are to be skipped. The operations of block 1820 may be performed in accordance with examples as disclosed herein. In some examples, aspects of the operations of 1820 may be performed by a UCI manager 935 as described with reference to FIG. 9.

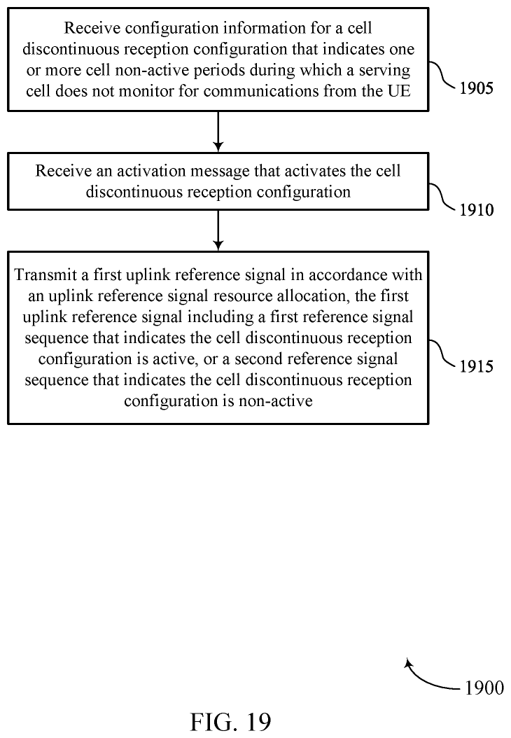

FIG. 19 shows a flowchart illustrating a method 1900 that supports techniques for confirmation of cell discontinuous transmission and reception activation in accordance with aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include receiving configuration information for a cell discontinuous reception configuration that indicates one or more cell non-active periods during which a serving cell does not monitor for communications from the UE. The operations of block 1905 may be performed in accordance with examples as disclosed herein. In some examples, aspects of the operations of 1905 may be performed by a configuration manager 925 as described with reference to FIG. 9.

At 1910, the method may include receiving an activation message that activates the cell discontinuous reception configuration. The operations of block 1910 may be performed in accordance with examples as disclosed herein. In some examples, aspects of the operations of 1910 may be performed by a DRX manager 930 as described with reference to FIG. 9.

At 1915, the method may include transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active. The operations of block 1915 may be performed in accordance with examples as disclosed herein. In some examples, aspects of the operations of 1915 may be performed by a reference signal manager 940 as described with reference to FIG. 9.

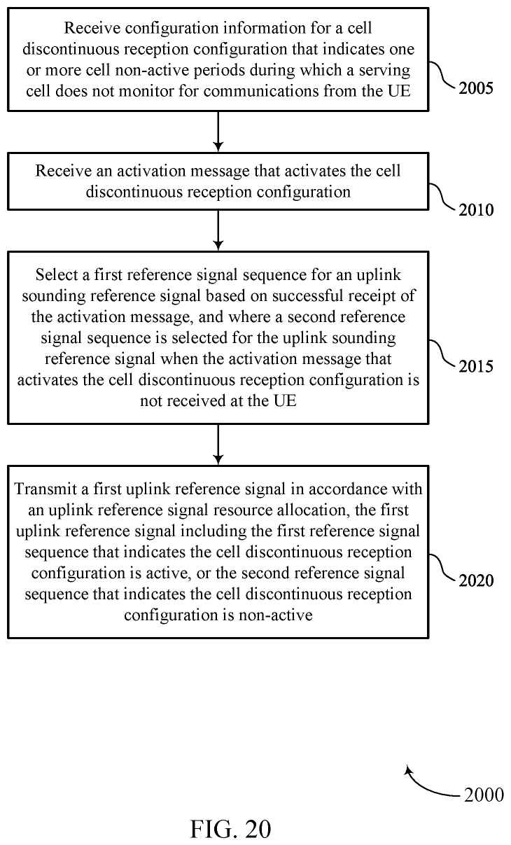

FIG. 20 shows a flowchart illustrating a method 2000 that supports techniques for confirmation of cell discontinuous transmission and reception activation in accordance with aspects of the present disclosure. The operations of the method 2000 may be implemented by a UE or its components as described herein. For example, the operations of the method 2000 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2005, the method may include receiving configuration information for a cell discontinuous reception configuration that indicates one or more cell non-active periods during which a serving cell does not monitor for communications from the UE. The operations of block 2005 may be performed in accordance with examples as disclosed herein. In some examples, aspects of the operations of 2005 may be performed by a configuration manager 925 as described with reference to FIG. 9.

At 2010, the method may include receiving an activation message that activates the cell discontinuous reception configuration. The operations of block 2010 may be performed in accordance with examples as disclosed herein. In some examples, aspects of the operations of 2010 may be performed by a DRX manager 930 as described with reference to FIG. 9.

At 2015, the method may include selecting a first reference signal sequence for an uplink sounding reference signal based on successful receipt of the activation message, and where a second reference signal sequence is selected for the uplink sounding reference signal when the activation message that activates the cell discontinuous reception configuration is not received at the UE. The operations of block 2015 may be performed in accordance with examples as disclosed herein. In some examples, aspects of the operations of 2015 may be performed by a reference signal manager 940 as described with reference to FIG. 9.

At 2020, the method may include transmitting a first uplink reference signal in accordance with an uplink reference signal resource allocation, the first uplink reference signal including the first reference signal sequence that indicates the cell discontinuous reception configuration is active, or the second reference signal sequence that indicates the cell discontinuous reception configuration is non-active. The operations of block 2020 may be performed in accordance with examples as disclosed herein. In some examples, aspects of the operations of 2020 may be performed by a reference signal manager 940 as described with reference to FIG. 9.

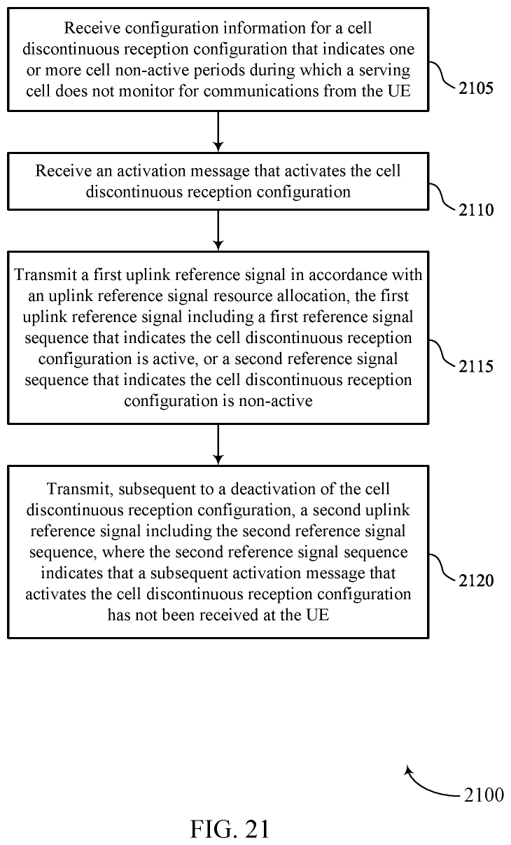

FIG. 21 shows a flowchart illustrating a method 2100 that supports techniques for confirmation of cell discontinuous transmission and reception activation in accordance with aspects of the present disclosure. The operations of the method 2100 may be implemented by a UE or its components as described herein. For example, the operations of the method 2100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2105, the method may include receiving configuration information for a cell discontinuous reception configuration that indicates one or more cell non-active periods during which a serving cell does not monitor for communications from the UE. The operations of block 2105 may be performed in accordance with examples as disclosed herein. In some examples, aspects of the operations of 2105 may be performed by a configuration manager 925 as described with reference to FIG. 9.

At 2110, the method may include receiving an activation message that activates the cell discontinuous reception configuration. The operations of block 2110 may be performed in accordance with examples as disclosed herein. In some examples, aspects of the operations of 2110 may be performed by a DRX manager 930 as described with reference to FIG. 9.

At 2115, the method may include transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active. The operations of block 2115 may be performed in accordance with examples as disclosed herein. In some examples, aspects of the operations of 2115 may be performed by a reference signal manager 940 as described with reference to FIG. 9.

At 2120, the method may include transmitting, subsequent to a deactivation of the cell discontinuous reception configuration, a second uplink reference signal including the second reference signal sequence, where the second reference signal sequence indicates that a subsequent activation message that activates the cell discontinuous reception configuration has not been received at the UE. The operations of block 2120 may be performed in accordance with examples as disclosed herein. In some examples, aspects of the operations of 2120 may be performed by a reference signal manager 940 as described with reference to FIG. 9.

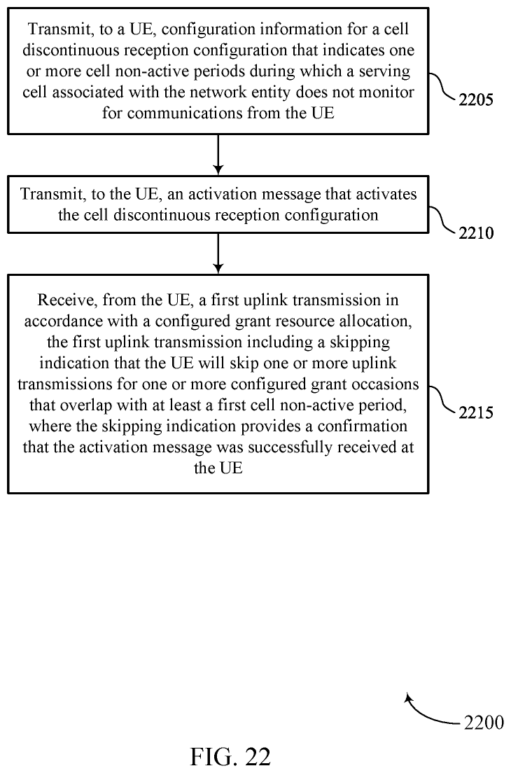

FIG. 22 shows a flowchart illustrating a method 2200 that supports techniques for confirmation of cell discontinuous transmission and reception activation in accordance with aspects of the present disclosure. The operations of the method 2200 may be implemented by a network entity or its components as described herein. For example, the operations of the method 2200 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2205, the method may include transmitting, to a UE, configuration information for a cell discontinuous reception configuration that indicates one or more cell non-active periods during which a serving cell associated with the network entity does not monitor for communications from the UE. The operations of block 2205 may be performed in accordance with examples as disclosed herein. In some examples, aspects of the operations of 2205 may be performed by a configuration manager 1325 as described with reference to FIG. 13.

At 2210, the method may include transmitting, to the UE, an activation message that activates the cell discontinuous reception configuration. The operations of block 2210 may be performed in accordance with examples as disclosed herein. In some examples, aspects of the operations of 2210 may be performed by a DRX manager 1330 as described with reference to FIG. 13.

At 2215, the method may include receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE. The operations of block 2215 may be performed in accordance with examples as disclosed herein. In some examples, aspects of the operations of 2215 may be performed by a UCI manager 1335 as described with reference to FIG. 13.

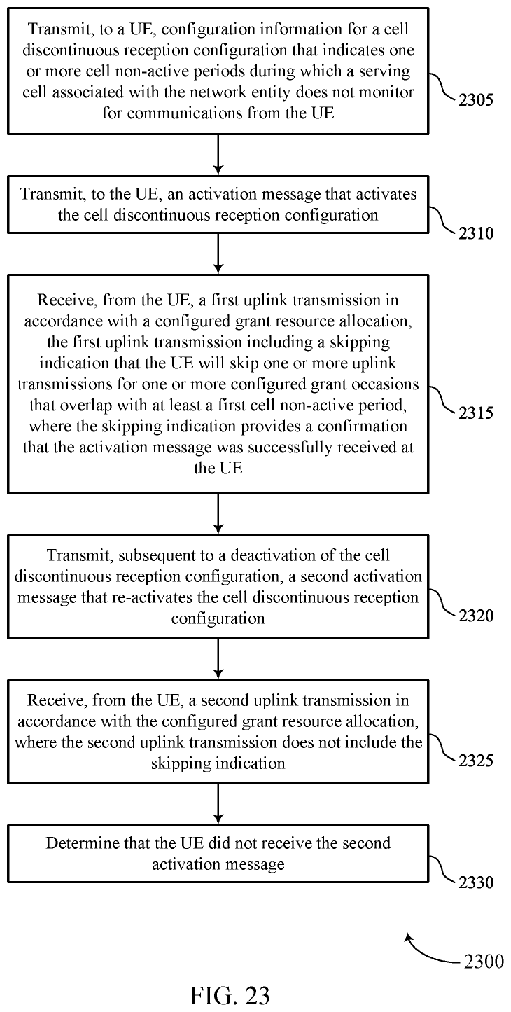

FIG. 23 shows a flowchart illustrating a method 2300 that supports techniques for confirmation of cell discontinuous transmission and reception activation in accordance with aspects of the present disclosure. The operations of the method 2300 may be implemented by a network entity or its components as described herein. For example, the operations of the method 2300 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2305, the method may include transmitting, to a UE, configuration information for a cell discontinuous reception configuration that indicates one or more cell non-active periods during which a serving cell associated with the network entity does not monitor for communications from the UE. The operations of block 2305 may be performed in accordance with examples as disclosed herein. In some examples, aspects of the operations of 2305 may be performed by a configuration manager 1325 as described with reference to FIG. 13.

At 2310, the method may include transmitting, to the UE, an activation message that activates the cell discontinuous reception configuration. The operations of block 2310 may be performed in accordance with examples as disclosed herein. In some examples, aspects of the operations of 2310 may be performed by a DRX manager 1330 as described with reference to FIG. 13.

At 2315, the method may include receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, where the skipping indication provides a confirmation that the activation message was successfully received at the UE. The operations of block 2315 may be performed in accordance with examples as disclosed herein. In some examples, aspects of the operations of 2315 may be performed by a UCI manager 1335 as described with reference to FIG. 13.

At 2320, the method may include transmitting, subsequent to a deactivation of the cell discontinuous reception configuration, a second activation message that re-activates the cell discontinuous reception configuration. The operations of block 2320 may be performed in accordance with examples as disclosed herein. In some examples, aspects of the operations of 2320 may be performed by a DRX manager 1330 as described with reference to FIG. 13.

At 2325, the method may include receiving, from the UE, a second uplink transmission in accordance with the configured grant resource allocation, where the second uplink transmission does not include the skipping indication. The operations of block 2325 may be performed in accordance with examples as disclosed herein. In some examples, aspects of the operations of 2325 may be performed by a UCI manager 1335 as described with reference to FIG. 13.

At 2330, the method may include determining that the UE did not receive the second activation message. The operations of block 2330 may be performed in accordance with examples as disclosed herein. In some examples, aspects of the operations of 2330 may be performed by a DRX manager 1330 as described with reference to FIG. 13.

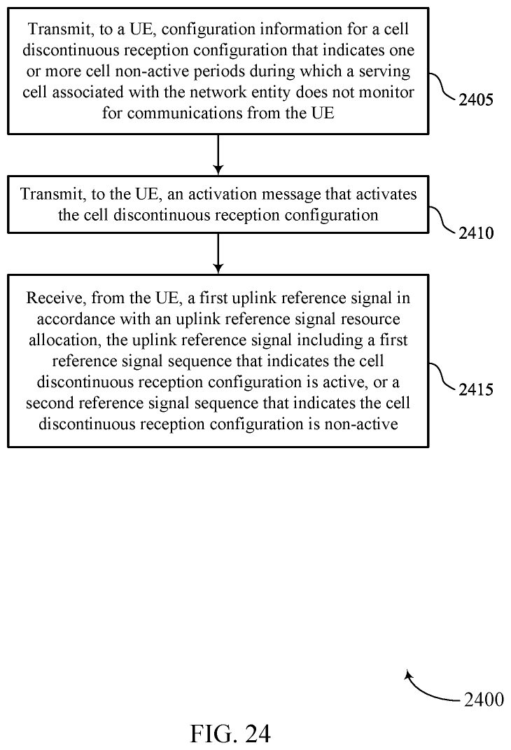

FIG. 24 shows a flowchart illustrating a method 2400 that supports techniques for confirmation of cell discontinuous transmission and reception activation in accordance with aspects of the present disclosure. The operations of the method 2400 may be implemented by a network entity or its components as described herein. For example, the operations of the method 2400 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2405, the method may include transmitting, to a UE, configuration information for a cell discontinuous reception configuration that indicates one or more cell non-active periods during which a serving cell associated with the network entity does not monitor for communications from the UE. The operations of block 2405 may be performed in accordance with examples as disclosed herein. In some examples, aspects of the operations of 2405 may be performed by a configuration manager 1325 as described with reference to FIG. 13.

At 2410, the method may include transmitting, to the UE, an activation message that activates the cell discontinuous reception configuration. The operations of block 2410 may be performed in accordance with examples as disclosed herein. In some examples, aspects of the operations of 2410 may be performed by a DRX manager 1330 as described with reference to FIG. 13.

At 2415, the method may include receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active. The operations of block 2415 may be performed in accordance with examples as disclosed herein. In some examples, aspects of the operations of 2415 may be performed by a reference signal manager 1340 as described with reference to FIG. 13.

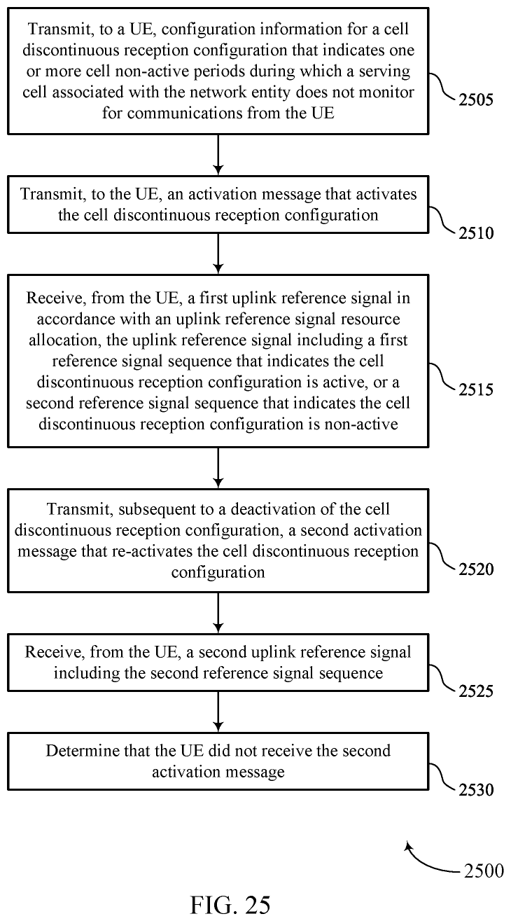

FIG. 25 shows a flowchart illustrating a method 2500 that supports techniques for confirmation of cell discontinuous transmission and reception activation in accordance with aspects of the present disclosure. The operations of the method 2500 may be implemented by a network entity or its components as described herein. For example, the operations of the method 2500 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2505, the method may include transmitting, to a UE, configuration information for a cell discontinuous reception configuration that indicates one or more cell non-active periods during which a serving cell associated with the network entity does not monitor for communications from the UE. The operations of block 2505 may be performed in accordance with examples as disclosed herein. In some examples, aspects of the operations of 2505 may be performed by a configuration manager 1325 as described with reference to FIG. 13.

At 2510, the method may include transmitting, to the UE, an activation message that activates the cell discontinuous reception configuration. The operations of block 2510 may be performed in accordance with examples as disclosed herein. In some examples, aspects of the operations of 2510 may be performed by a DRX manager 1330 as described with reference to FIG. 13.

At 2515, the method may include receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active. The operations of block 2515 may be performed in accordance with examples as disclosed herein. In some examples, aspects of the operations of 2515 may be performed by a reference signal manager 1340 as described with reference to FIG. 13.

At 2520, the method may include transmitting, subsequent to a deactivation of the cell discontinuous reception configuration, a second activation message that re-activates the cell discontinuous reception configuration. The operations of block 2520 may be performed in accordance with examples as disclosed herein. In some examples, aspects of the operations of 2520 may be performed by a DRX manager 1330 as described with reference to FIG. 13.

At 2525, the method may include receiving, from the UE, a second uplink reference signal including the second reference signal sequence. The operations of block 2525 may be performed in accordance with examples as disclosed herein. In some examples, aspects of the operations of 2525 may be performed by a reference signal manager 1340 as described with reference to FIG. 13.

At 2530, the method may include determining that the UE did not receive the second activation message. The operations of block 2530 may be performed in accordance with examples as disclosed herein. In some examples, aspects of the operations of 2530 may be performed by a DRX manager 1330 as described with reference to FIG. 13.

The following provides an overview of aspects of the present disclosure:

Aspect 1: A method for wireless communications at a UE, comprising: receiving configuration information for a cell discontinuous reception configuration that indicates one or more cell non-active periods during which a serving cell does not monitor for communications from the UE; receiving an activation message that activates the cell discontinuous reception configuration; and transmitting a first uplink transmission in accordance with a configured grant resource allocation, the first uplink transmission including a skipping indication that the UE will skip one or more uplink transmissions for one or more configured grant occasions that overlap with at least a first cell non-active period, wherein the skipping indication provides a confirmation that the activation message was successfully received at the UE.

Aspect 2: The method of aspect 1, wherein the first uplink transmission is transmitted in a last configured grant resource allocation within a cell active period prior to the first cell non-active period.

Aspect 3: The method of any of aspects 1 through 2, further comprising: determining the one or more configured grant occasions that overlap with the first cell non-active period, and wherein the skipping indication identifies each of the one or more configured grant occasions that overlap with the first cell non-active period.

Aspect 4: The method of any of aspects 1 through 3, further comprising: transmitting, subsequent to a deactivation of the cell discontinuous reception configuration, a second uplink transmission in accordance with the configured grant resource allocation, wherein the second uplink transmission does not include the skipping indication and signals that a subsequent activation message that activates the cell discontinuous reception configuration has not been received at the UE.

Aspect 5: The method of any of aspects 1 through 4, wherein the skipping indication is provided in uplink control information (UCI) included with the first uplink transmission.

Aspect 6: The method of aspect 5, wherein the skipping indication includes a bitmap of the one or more configured grant occasions that overlap with the first cell non-active period.

Aspect 7: The method of any of aspects 5 through 6, wherein the UCI has a same UCI format as a first UCI format that indicates skipping at the UE due to a lack of data to transmit, or has a different UCI format than the first UCI format.

Aspect 8: The method of any of aspects 1 through 7, wherein the skipping indication provides both the confirmation that the activation message was successfully received at the UE and an indication that one or more configured grant occasions that overlap with a cell active period are to be skipped.

Aspect 9: The method of aspect 8, wherein the skipping indication includes a bitmap of the one or more configured grant occasions that overlap with the first cell non-active period and the cell active period.

Aspect 10: The method of any of aspects 1 through 9, wherein the transmitting the first uplink transmission further comprises: multiplexing uplink control information (UCI) that includes the skipping indication with a physical uplink shared channel transmission that is included in the first uplink transmission, and wherein the UCI has a higher priority than other UCI that indicates only that one or more configured grant occasions that overlap with a cell active period are to be skipped.

Aspect 11: A method for wireless communications at a UE, comprising: receiving configuration information for a cell discontinuous reception configuration that indicates one or more cell non-active periods during which a serving cell does not monitor for communications from the UE; receiving an activation message that activates the cell discontinuous reception configuration; and transmitting a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

Aspect 12: The method of aspect 11, further comprising: selecting the first reference signal sequence for an uplink sounding reference signal based at least in part on successful receipt of the activation message, and wherein the second reference signal sequence is selected for the uplink sounding reference signal when the activation message that activates the cell discontinuous reception configuration is not received at the UE.

Aspect 13: The method of aspect 12, wherein the first reference signal sequence is determined based at least in part on a first seed value for reference signal generation, and the second reference signal sequence is determined based at least in part on a second seed value for reference signal generation.

Aspect 14: The method of any of aspects 11 through 13, further comprising: transmitting, subsequent to a deactivation of the cell discontinuous reception configuration, a second uplink reference signal including the second reference signal sequence, wherein the second reference signal sequence indicates that a subsequent activation message that activates the cell discontinuous reception configuration has not been received at the UE.

Aspect 15: The method of aspect 14, wherein the first uplink reference signal and the second uplink reference signal are sounding reference signals.

Aspect 16: A method for wireless communications at a network entity, comprising: transmitting, to a UE, configuration information for a cell discontinuous reception configuration that indicates one or more cell non-active periods during which a serving cell associated with the network entity does not monitor for communications from the UE; transmitting, to the UE, an activation message that activates the cell discontinuous reception configuration; and receiving, from the UE, a first uplink transmission in accordance with a configured grant resource allocation, the first uplink transmission including a skipping indication that the UE will skip one or more uplink transmissions for one or more configured grant occasions that overlap with at least a first cell non-active period, wherein the skipping indication provides a confirmation that the activation message was successfully received at the UE.

Aspect 17: The method of aspect 16, wherein the first uplink transmission is transmitted in a last configured grant resource allocation within a cell active period prior to the first cell non-active period.

Aspect 18: The method of any of aspects 16 through 17, wherein the skipping indication identifies each of the one or more configured grant occasions that overlap with the first cell non-active period.

Aspect 19: The method of any of aspects 16 through 18, further comprising: transmitting, subsequent to a deactivation of the cell discontinuous reception configuration, a second activation message that re-activates the cell discontinuous reception configuration; receiving, from the UE, a second uplink transmission in accordance with the configured grant resource allocation, wherein the second uplink transmission does not include the skipping indication; and determining that the UE did not receive the second activation message.

Aspect 20: The method of any of aspects 16 through 19, wherein the skipping indication is provided in uplink control information (UCI) included with the first uplink transmission.

Aspect 21: The method of aspect 20, wherein the skipping indication includes a bitmap of the one or more configured grant occasions that overlap with the first cell non-active period.

Aspect 22: The method of any of aspects 20 through 21, wherein the UCI has a same UCI format as a first UCI format that indicates skipping at the UE due to a lack of data to transmit, or has a different UCI format than the first UCI format.

Aspect 23: The method of any of aspects 16 through 22, wherein the skipping indication provides both the confirmation that the activation message was successfully received at the UE and an indication that one or more configured grant occasions that overlap with a cell active period are to be skipped.

Aspect 24: The method of aspect 23, wherein the skipping indication includes a bitmap of the one or more configured grant occasions that overlap with the first cell non-active period and the cell active period.

Aspect 25: The method of any of aspects 16 through 24, wherein the receiving the first uplink transmission further comprises: demultiplexing uplink control information (UCI) that includes the skipping indication and a physical uplink shared channel transmission that is included in the first uplink transmission, and wherein the UCI has a higher priority than other UCI that indicates only that one or more configured grant occasions that overlap with a cell active period are to be skipped.

Aspect 26: A method for wireless communications at a network entity, comprising: transmitting, to a UE, configuration information for a cell discontinuous reception configuration that indicates one or more cell non-active periods during which a serving cell associated with the network entity does not monitor for communications from the UE; transmitting, to the UE, an activation message that activates the cell discontinuous reception configuration; and receiving, from the UE, a first uplink reference signal in accordance with an uplink reference signal resource allocation, the uplink reference signal including a first reference signal sequence that indicates the cell discontinuous reception configuration is active, or a second reference signal sequence that indicates the cell discontinuous reception configuration is non-active.

Aspect 27: The method of aspect 26, wherein the first reference signal sequence is provided in an uplink sounding reference signal and indicates successful receipt of the activation message, and the second reference signal sequence is provided in the uplink sounding reference signal when the activation message is not successfully decoded at the UE.

Aspect 28: The method of aspect 27, wherein the first reference signal sequence is determined based at least in part on a first seed value for reference signal generation, and the second reference signal sequence is determined based at least in part on a second seed value for reference signal generation.

Aspect 29: The method of any of aspects 26 through 28, further comprising: transmitting, subsequent to a deactivation of the cell discontinuous reception configuration, a second activation message that re-activates the cell discontinuous reception configuration; receiving, from the UE, a second uplink reference signal including the second reference signal sequence; and determining that the UE did not receive the second activation message.

Aspect 30: The method of aspect 29, wherein the first uplink reference signal and the second uplink reference signal are sounding reference signals.

Aspect 31: A UE for wireless communications, comprising one or more memories storing processor-executable code, and one or more processors coupled with the one or more memories and individually or collectively operable to execute the code to cause the UE to perform a method of any of aspects 1 through 10.

Aspect 32: A UE for wireless communications, comprising at least one means for performing a method of any of aspects 1 through 10.

Aspect 33: A non-transitory computer-readable medium storing code for wireless communications, the code comprising instructions executable by one or more processors to perform a method of any of aspects 1 through 10.

Aspect 34: A UE for wireless communications, comprising one or more memories storing processor-executable code, and one or more processors coupled with the one or more memories and individually or collectively operable to execute the code to cause the UE to perform a method of any of aspects 11 through 15.

Aspect 35: A UE for wireless communications, comprising at least one means for performing a method of any of aspects 11 through 15.

Aspect 36: A non-transitory computer-readable medium storing code for wireless communications, the code comprising instructions executable by one or more processors to perform a method of any of aspects 11 through 15.

Aspect 37: A network entity for wireless communications, comprising one or more memories storing processor-executable code, and one or more processors coupled with the one or more memories and individually or collectively operable to execute the code to cause the network entity to perform a method of any of aspects 16 through 25.

Aspect 38: A network entity for wireless communications, comprising at least one means for performing a method of any of aspects 16 through 25.

Aspect 39: A non-transitory computer-readable medium storing code for wireless communications, the code comprising instructions executable by one or more processors to perform a method of any of aspects 16 through 25.

Aspect 40: A network entity for wireless communications, comprising one or more memories storing processor-executable code, and one or more processors coupled with the one or more memories and individually or collectively operable to execute the code to cause the network entity to perform a method of any of aspects 26 through 30.

Aspect 41: A network entity for wireless communications, comprising at least one means for performing a method of any of aspects 26 through 30.

Aspect 42: A non-transitory computer-readable medium storing code for wireless communications, the code comprising instructions executable by one or more processors to perform a method of any of aspects 26 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information for a cell discontinuous reception configuration that indicates one or more cell non-active periods during which a serving cell does not monitor for communications from the UE;
receive an activation message that activates the cell discontinuous reception configuration; and
transmit a first uplink transmission in accordance with a configured grant resource allocation, the first uplink transmission including a skipping indication that the UE will skip one or more uplink transmissions for one or more configured grant occasions that overlap with at least a first cell non-active period, wherein the skipping indication provides a confirmation that the activation message was successfully received at the UE.

2. The UE of claim 1, wherein the first uplink transmission is transmitted in a last configured grant resource allocation within a cell active period prior to the first cell non-active period.

3. The UE of claim 1, wherein the one or more processors are individually or collectively further operable to execute the code to cause the UE to:
determine the one or more configured grant occasions that overlap with the first cell non-active period, and wherein the skipping indication identifies each of the one or more configured grant occasions that overlap with the first cell non-active period.

4. The UE of claim 1, wherein the one or more processors are individually or collectively further operable to execute the code to cause the UE to:
transmit, subsequent to a deactivation of the cell discontinuous reception configuration, a second uplink transmission in accordance with the configured grant resource allocation, wherein the second uplink transmission does not include the skipping indication and signals that a subsequent activation message that activates the cell discontinuous reception configuration has not been received at the UE.

5. The UE of claim 1, wherein the skipping indication is provided in uplink control information (UCI) included with the first uplink transmission.

6. The UE of claim 5, wherein the skipping indication includes a bitmap of the one or more configured grant occasions that overlap with the first cell non-active period.

7. The UE of claim 5, wherein the UCI has a same UCI format as a first UCI format that indicates skipping at the UE due to a lack of data to transmit, or has a different UCI format than the first UCI format.

8. The UE of claim 1, wherein the skipping indication provides both the confirmation that the activation message was successfully received at the UE and an indication that one or more configured grant occasions that overlap with a cell active period are to be skipped.

9. The UE of claim 8, wherein the skipping indication includes a bitmap of the one or more configured grant occasions that overlap with the first cell non-active period and the cell active period.

10. The UE of claim 1, wherein, to transmit the first uplink transmission, the one or more processors are individually or collectively further operable to execute the code to cause the UE to:
multiplex uplink control information (UCI) that includes the skipping indication with a physical uplink shared channel transmission that is included in the first uplink transmission, and wherein the UCI has a higher priority than other UCI that indicates only that one or more configured grant occasions that overlap with a cell active period are to be skipped.

11. A user equipment (UE), comprising:
one or more memories storing processor-executable code; and
one or more processors coupled with the one or more memories and individually or collectively operable to execute the code to cause the UE to:
receive configuration information for a cell discontinuous reception configuration that indicates one or more cell non-active periods during which a serving cell does not monitor for communications from the UE;
receive an activation message that activates the cell discontinuous reception configuration; and
transmit a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

12. The UE of claim 11, wherein the one or more processors are individually or collectively further operable to execute the code to cause the UE to:
select the first reference signal sequence for an uplink sounding reference signal based at least in part on successful receipt of the activation message, and wherein the second reference signal sequence is selected for the uplink sounding reference signal when the activation message that activates the cell discontinuous reception configuration is not received at the UE.

13. The UE of claim 12, wherein the first reference signal sequence is determined based at least in part on a first seed value for reference signal generation, and the second reference signal sequence is determined based at least in part on a second seed value for reference signal generation.

14. The UE of claim 11, wherein the one or more processors are individually or collectively further operable to execute the code to cause the UE to:
transmit, subsequent to a deactivation of the cell discontinuous reception configuration, a second uplink reference signal including the second reference signal sequence, wherein the second reference signal sequence indicates that a subsequent activation message that activates the cell discontinuous reception configuration has not been received at the UE.

15. The UE of claim 14, wherein:
the first uplink reference signal and the second uplink reference signal are sounding reference signals.

16. A network entity, comprising:
one or more memories storing processor-executable code; and
one or more processors coupled with the one or more memories and individually or collectively operable to execute the code to cause the network entity to:
transmit, to a user equipment (UE), configuration information for a cell discontinuous reception configuration that indicates one or more cell non-active periods during which a serving cell associated with the network entity does not monitor for communications from the UE;
transmit, to the UE, an activation message that activates the cell discontinuous reception configuration; and
receive, from the UE, a first uplink transmission in accordance with a configured grant resource allocation, the first uplink transmission including a skipping indication that the UE will skip one or more uplink transmissions for one or more configured grant occasions that overlap with at least a first cell non-active period, wherein the skipping indication provides a confirmation that the activation message was successfully received at the UE.

17. The network entity of claim 16, wherein the first uplink transmission is transmitted in a last configured grant resource allocation within a cell active period prior to the first cell non-active period.

18. The network entity of claim 16, wherein the skipping indication identifies each of the one or more configured grant occasions that overlap with the first cell non-active period.

19. The network entity of claim 16, wherein the one or more processors are individually or collectively further operable to execute the code to cause the network entity to:
transmit, subsequent to a deactivation of the cell discontinuous reception configuration, a second activation message that re-activates the cell discontinuous reception configuration;
receive, from the UE, a second uplink transmission in accordance with the configured grant resource allocation, wherein the second uplink transmission does not include the skipping indication; and
determine that the UE did not receive the second activation message.

20. The network entity of claim 16, wherein the skipping indication is provided in uplink control information (UCI) included with the first uplink transmission.

21. The network entity of claim 20, wherein the skipping indication includes a bitmap of the one or more configured grant occasions that overlap with the first cell non-active period.

22. The network entity of claim 20, wherein the UCI has a same UCI format as a first UCI format that indicates skipping at the UE due to a lack of data to transmit, or has a different UCI format than the first UCI format.

23. The network entity of claim 16, wherein the skipping indication provides both the confirmation that the activation message was successfully received at the UE and an indication that one or more configured grant occasions that overlap with a cell active period are to be skipped.

24. The network entity of claim 23, wherein the skipping indication includes a bitmap of the one or more configured grant occasions that overlap with the first cell non-active period and the cell active period.

25. The network entity of claim 16, wherein, to receive the first uplink transmission, the one or more processors are individually or collectively further operable to execute the code to cause the network entity to:
demultiplex uplink control information (UCI) that includes the skipping indication and a physical uplink shared channel transmission that is included in the first uplink transmission, and wherein the UCI has a higher priority than other UCI that indicates only that one or more configured grant occasions that overlap with a cell active period are to be skipped.

26. A network entity, comprising:
one or more memories storing processor-executable code; and
one or more processors coupled with the one or more memories and individually or collectively operable to execute the code to cause the network entity to:
transmit, to a user equipment (UE), configuration information for a cell discontinuous reception configuration that indicates one or more cell non-active periods during which a serving cell associated with the network entity does not monitor for communications from the UE;
transmit, to the UE, an activation message that activates the cell discontinuous reception configuration; and
receive, from the UE, a first uplink reference signal in accordance with an uplink reference signal resource allocation, the first uplink reference signal including a first reference signal sequence that indicates the cell discontinuous reception configuration is active, or a second reference signal sequence that indicates the cell discontinuous reception configuration is non-active.

27. The network entity of claim 26, wherein the first reference signal sequence is provided in an uplink sounding reference signal and indicates successful receipt of the activation message, and the second reference signal sequence is provided in the uplink sounding reference signal when the activation message is not successfully decoded at the UE.

28. The network entity of claim 27, wherein the first reference signal sequence is determined based at least in part on a first seed value for reference signal generation, and the second reference signal sequence is determined based at least in part on a second seed value for reference signal generation.

29. The network entity of claim 26, wherein the one or more processors are individually or collectively further operable to execute the code to cause the network entity to:
transmit, subsequent to a deactivation of the cell discontinuous reception configuration, a second activation message that re-activates the cell discontinuous reception configuration;
receive, from the UE, a second uplink reference signal including the second reference signal sequence; and
determine that the UE did not receive the second activation message.

30. The network entity of claim 29, wherein:
the first uplink reference signal and the second uplink reference signal are sounding reference signals.
